(19) United States
(12) Patent Application Publication
(10) Pub. No.: US 2004/0249534 A1
(43) Pub. Date: Dec. 9, 2004

(54) Power supply management system for vehicle mounted apparatus

(76) Inventors: Kunihiro Yamada, Okazaki (JP); Satoshi Ogawa, Okazaki (JP); Nobuo Suzuki, Okazaki (JP); Akihiro Nakajima, Okazaki (JP)

Correspondence Address: Oliff & Berridge, PO Box 19928, Alexandria, VA, 22320, US

(21) Appl. No.: 10/491,173

(22) PCT Filed: Apr. 14, 2003
(86) PCT No.: PCT/JP03/04713

(30) Foreign Application Priority Data
Apr. 12, 2002 (JP) 2002-111097

(51) Int. Cl. G06F 19/00

(52) U.S. Cl. 701/36; 701/200; 307/10.1

(57) ABSTRACT

A power supply management system and method for an on-board device that, when required by a user of the on-board device and/or when a power supply is capable of supplying electric power, allows remote operation of the on-board device by supplying electric power to a communication device so as to place it in a communication-capable state. Further, when not required by the user of the on-board device and/or when the power supply is not capable of supplying electric power, it is possible to inhibit discharge of a power supply by interrupting supply of electric power to the communication device.

### BACKGROUND OF THE INVENTION

1. Field of Invention

The present invention relates to a power supply management system for an on-board device.

2. Description of Related Art

Conventionally, systems have been provided for a vehicle with a mounted navigation device in which a driver transmits route guidance information data to the navigation device in advance such that it is possible to start guidance in accordance with the transmitted route guidance information data when the driver gets in the vehicle and starts driving (refer to Japanese Patent Laid-Open Publications Hei 6-243395 and Hei 9-189566). In this case, while the vehicle is parked, the driver can use a personal computer, or the like, in their home or at their office, and conduct a route search by inputting a target destination, search conditions, or the like. The found route guidance data is then transmitted to the navigation device wirelessly, or the like. Accordingly, when the driver gets in to the vehicle and starts to drive, they can use the route guidance immediately.

However, with such conventional systems, while the vehicle is parked, vehicle on-board devices like the navigation device, an on-board audio device, and the like, are operated. As a result, it is necessary to supply electric power to the vehicle on-board devices. Since an engine of the vehicle is generally stopped while the vehicle is parked, an alternator that is attached to the engine is also stopped. Accordingly, it becomes necessary to utilize a vehicle battery as a power supply. The capacity of the vehicle battery is limited.

To address this, a system has been proposed (refer to Japanese Patent Laid-Open Publication Hei 10-290193) in which vehicle on-board devices are placed in a sleep mode so as to reduce consumed electric power during parking, and then at a predetermined time, the vehicle on-board devices are revived using a timer. In addition, a system has been proposed (refer to Japanese Patent Laid-Open Publication Hei 10-241095) in which a state of charge of the vehicle battery is monitored from outside of the vehicle, and, as necessary, the engine is started so as to cause the alternator to operate and the vehicle battery to be recharged. In this case, the state of charge of the vehicle battery can be monitored with a road side information processing device, by executing communication between the road side information processing device, which is provided in the home or elsewhere, and an on-board information processing device.

In order to execute communication between the road side information processing device and the on-board information processing device, the on-board information processing device must constantly be on stand-by for communication. In other words, the on-board information processing device needs to be in a communication-capable state. However, since the on-board vehicle processing device is on stand-by for communication, electric power is consumed.

### SUMMARY OF THE INVENTION

In order to address the above described problems of the conventional systems, various exemplary embodiments of this invention provide a power supply management system for an on-board device which, when required by a user of the on-board device and when a power supply is capable of supplying electric power, allows remote operation of the on-board device by supplying electric power to a communication device so as to place it in a communication-capable state. Further, when not required by the user of the on-board device and when the power supply is not capable of supplying electric power, it is possible to inhibit discharge of a vehicle battery that acts as the power supply by interrupting supply of electric power to the communication device.

Accordingly, various exemplary embodiments of the invention provide a power supply management system for an on-board device, including at least one controller that controls start-up of an on-board device; causes, upon receipt of a start-up request from outside of the on-board device, start-up of at least a portion of the on-board device; determines whether a user has a remote control operation intention; and permits, upon determination that the user has the remote control operation intention, supply of electric power to start-up the at least a portion of the on-board device.

Various exemplary embodiments of the invention provide a power supply management system for an on-board device, including at least one controller that controls start-up of an on-board device; determines whether a user has a remote control operation intention; and permits, upon determination that the user has the remote control operation intention, supply of electric power to receive a data signal; and causes, upon receipt of the data signal from outside of the on-board device, start-up of at least a portion of the on-board device.

Various exemplary embodiments of the invention provide a power supply management system for an on-board device, including at least one controller that controls start-up of an on-board device; determines whether a power supply has electric power, supply capability; permits, upon determination that the power supply has electric power supply capability, supply of electric power to receive a start-up request from outside the on-board device; and causes, upon receipt of the start-up request from outside of the on-board device, start up of at least a portion of the on-board device.

Various exemplary embodiments of the invention provide a power supply management system for an on-board device, including at least one controller that controls start-up of an on-board device; determines whether a power supply has electric power supply capability; permits, upon determination that the power supply has electric power supply capability, supply of electric power to receive a data signal from outside the on-board device; and causes, upon receipt of the data signal from outside of the on-board device, start-up of at least a portion of the on-board device.

Various exemplary embodiments of the invention provide a method for managing the power supply of an on-board device, including receiving a start-up request; determining whether a user has an intention to remotely control the on-board device; and starting-up, if the user has an intention to remotely control the on-board device, at least a portion of the on-board device.;

### BRIEF DESCRIPTION OF THE DRAWINGS

Exemplary embodiments of the invention will now be described with reference to the accompanying drawings, wherein:

FIG. 1 shows a configuration of a power supply management system for an on-board device of a first exemplary embodiment of the invention;

FIG. 2 shows a configuration of a communication system for the on-board device and an external device of the first exemplary embodiment of the invention;

FIG. 3 shows a configuration of the first exemplary embodiment of the invention when the on-board device is a vehicular navigation device;

FIG. 4 shows a configuration of the power supply management system for an on-board device of the first exemplary embodiment of the invention when the on-board device is the vehicular navigation device;

FIG. 5 is a flow chart showing an operation of the power supply management system for an on-board device of the first exemplary embodiment of the invention;

FIG. 6 is a flow chart showing an operation of the power supply management system for an on-board device of the first exemplary embodiment of the invention when a condition set by a user is a position;

FIG. 7 is a flow chart showing an operation of the power supply management system for an on-board device of the first exemplary embodiment of the invention when the condition set by the user is a time/date;

FIG. 8 is a flow chart showing an operation of a power supply control portion of the first exemplary embodiment of the invention when the condition set by the user is a position and a time/date;

FIG. 9 is a flow chart showing an operation of the first exemplary embodiment of the invention from when the on-board device is started up to when it is stopped;

FIG. 10 is a flow chart showing an operation of the first exemplary embodiment of the invention when on-board device start-up processing is executed by specified low-power wireless, and when data transmission processing is executed by wireless LAN;

FIG. 11 is a flow chart showing an operation of the first exemplary embodiment of the invention when the on-board device start-up processing is executed by wireless LAN, and the data transmission processing is executed by wireless LAN;

FIG. 12 shows a configuration of a power supply management system for an on-board device of a second exemplary embodiment of the invention;

FIG. 13 shows a configuration of a power supply management system for an on-board device of a third exemplary embodiment of the invention;

FIG. 14 is a flow chart showing an operation of the power supply management system for an on-board device of the third exemplary embodiment of the invention;

FIG. 15 shows a configuration of a power supply management system for an on-board device of a fourth exemplary embodiment of the invention;

FIG. 16 shows a configuration of the power supply management system for an on-board device of the fourth exemplary embodiment of the invention when the on-board device is a vehicular navigation device;

FIG. 17 is a flow chart showing an operation of the power supply management system for an on-board device of the fourth exemplary embodiment of the invention;

FIG. 18 is a flow chart showing an operation of the power supply management system for an on-board device of the fourth exemplary embodiment of the invention when an environmental condition is an outside temperature;

FIG. 19 is a flow chart showing an operation of the power supply management system for an on-board device of the fourth exemplary embodiment of the invention when information indicating electric power supply capability is an inter-terminal voltage of a power supply;

FIG. 20 is a flow chart showing an operation of a power supply control portion of the fourth exemplary embodiment of the invention when the information indicating electric power supply capability is an electrolyte volume of the power supply;

FIG. 21 is a flow chart showing an operation of the power supply control portion of the fourth exemplary embodiment of the invention when the information indicating electric power supply capability is a usage period of the power supply;

FIG. 22 shows a configuration of a power supply management system for an on-board device of a fifth exemplary embodiment of the invention;

FIG. 23 shows a configuration of a power supply management system for an on-board device of a sixth exemplary embodiment of the invention; and

FIG.24 is flow chart showing an operation of the power supply management system for an on-board device of the sixth exemplary embodiment.

### DETAILED DESCRIPTION OF EXEMPLARY EMBODIMENTS

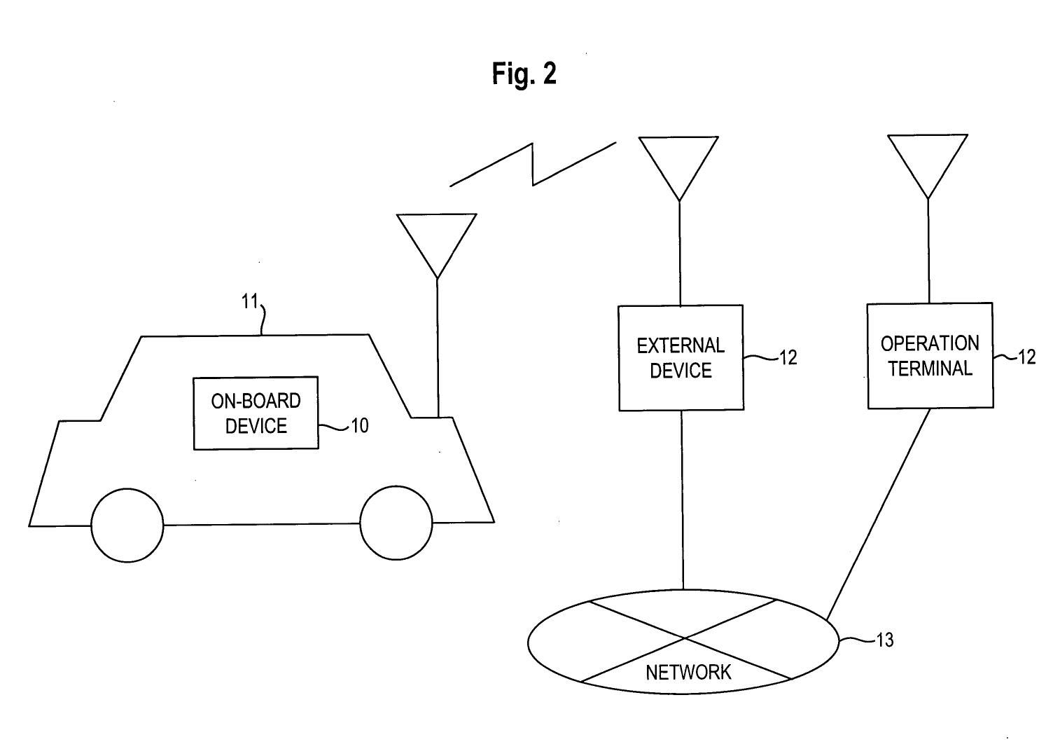

FIG. 2 shows a configuration of a communication system for an on-board device and an external device according to a first exemplary embodiment of the invention. FIG. 2 shows a vehicle 11, such as an automobile, a truck, a bus or a motorbike, with an on-board device 10 that is mounted in the vehicle 1 1 and which is a type of computer provided with a calculation unit such as a CPU or MPU; a storage unit such as a semi-conductor memory or a magnetic disk; a display unit such as a CRT, a liquid crystal display, or an LED (Light Emitting Diode) display; an input unit such as a keyboard, ajoy-stick, a touch panel, a push button, a rotating dial or a remote controller; an input-output interface, and the like. Note that the on-board device 10 may use any form of storage medium as the storage unit, such as a magnetic tape, a magnetic disk, a magnetic drum, a CD-ROM, a CD-R/W, an MD, a DVD-ROM, a DVD-R/W, a DVD-RAM, an optical disk, an MO, an IC card, an optical card, a memory card, or a memory stick. According to this exemplary embodiment, the on-board device 10 is, for example, a vehicular navigation device, an on-board computer, a vehicular audio device, a vehicular video replay device, an engine starter device, or a theft prevention security device, or the like. However, it may be another type of device. For ease of explanation, it is assumed that the on-board device 10 is a vehicular navigation device. In addition, the on-board device 10 may be a plurality of devices. However, in FIG. 2, for the sake of simplicity, the on-board device 10 may be considered as a representative example for a plurality of devices.

As shown in FIG. 2, an external device 12 is provided outside of the vehicle 11 that acts as a relay apparatus between a network 13 and the on-board device 10. The external device 12 functions as an access point to the network 13 from the on-board device 10. Here, the external device 12 is, for example, a wireless LAN adapter which communicates with the on-board device 10 using 2.4 (GHz) ISM band, 5.2 (GHz) band, or 19 (GHz) band sub-millimeter-waves, infrared rays, or the like. The wireless LAN system in this case is, for example, IEEE808.11a, IEEE808.11b, IEEE808.11e adopted as awireless LAN system, or Bluetooth, or the like, adopted as a home wireless system. However, any type of wireless system may be adopted. For example, a transmission method like DSRC in an ETC system may be utilized. Note that, the external device 12 may be a server for a relay station that is a type of computer provided with a calculation unit such as a CPU or MPU; a storage unit such as a semi-conductor memory or a magnetic disk; a display unit such as a CRT, a liquid crystal display, or an LED display; an input unit such as a keyboard or a remote controller; an input-output interface, and the like.

In this case, the external device 12 is located close to a parking space of the vehicle 11 such that communication is executed with the on-board device 10 of the vehicle 11 that is parked in the parking space. For example, it is preferable, if in the case that the vehicle 11 is parked in a parking space at the driver's home or a parking space near to the driver's home, the external device 12 is located within the driver's home, in the case that the vehicle 11 is parked in a pay parking lot, the external device 12 is located within the pay parking lot, and, in the case that the vehicle 11 is parked in a parking space on a road, the external device 12 is located in a parking meter, or the like.

Moreover, the network 13 is a backbone network of the external device 12, and may be any type of network such as a wired or wireless public network, a dedicate line network, the Internet, an intranet, LAN, and WAN (Wide Area Network). Further, it may be a plurality of types of communication networks that are suitably combined. It is preferable if an information supply device like a web server, which supplies various types of data such as map data, music data, image data, and character data, can be accessed via the network 13. In this case, it is preferable if the network 13 is capable of high capacity, high speed communication. For example, in the case that the network 13 is the Internet; broad band that is capable of high speed communication at a number of Mbps (Mega bit per second) or more is adopted. However, another communication system may be utilized.

Reference numeral 14 is an operation terminal which is operated by a user or operator such as a driver, a passenger, or an owner, and which is a type of computer that is provided with a calculation unit such as a CPU or MPU; a storage unit such as a semi-conductor memory or a magnetic disk; a display unit such as a CRT, a liquid crystal display, or an LED display; an input unit such as a keyboard, a joy-stick, a touch panel, a tablet, a. push button, a rotating dial or a remote controller; an input-output interface, and the like. Further, the operation terminal 14 may be, for example, any type of device such as a personal computer, a mobile phone device, a PHS (Personal Handy-Phone System) device, a stationary telephone device, a PDA (Personal Digital Assistant), an electronic hand-held organizer, a mobile information terminal, a game machine, a digital television, or the like. Moreover, the operation terminal 14 is connected to the external device 12, and can communicate with the on-board device 10 via the external device 12. Note that the operation terminal 14 may be capable of direct connection to the external device 12 by wire or wirelessly, and may be connectable via the network 13.

According to this exemplary embodiment, while the vehicle 11 is parked at a predetermined parking space, the on-board device 10 is connected to the operation terminal 14 and the network 13 via the external device 12, and is capable of communication with a web server, not shown. For example, assuming the on-board device 10 is a vehicular navigation device, the operation terminal 14 is a personal computer provided at the home of the driver who is the user, the external device 12 is provided within the driver's home, and the vehicle 11 is parked in a parking space at the user's home or in a parking space near their home. In this case, the user can operate the personal computer as the operation terminal 14, and remotely operate the on-board device 10. For example, the user can operate the operation terminal 14 so as to set a target destination, search conditions, and the like, and transmit the settings to the on-board device 10. As a result, the on-board device 10 is able to automatically search for the route to the target destination, complete this search and start route guidance by the time the user gets in to the vehicle 11 and starts driving. Information concerning the route that is received from the on-board device 10 can be displayed on the operation terminal 14. In addition, when the network 13 is connected to a web server that provides the latest version of map data, the user can operate the operation terminal 14 so as to remotely operate the on-board device 10. Accordingly, desired map data can be downloaded from the web server, transmitted to the on-board device 10, and used for updating the version of the map data stored in the on-board device 10. Note that the map data may also be directly downloaded from the web server to the on-board device 10.

In the case that the on-board device 10 is an on-board computer, the user can remotely operate the on-board device 10 so as to communicate between the operation terminal 14 and the on-board device 10, or run an application program on the on-board device 10. Note that desired data may also be downloaded to the on-board device 10 from the web server.

In the case that the on-board device 10 is a vehicular audio device, the user can operate the operation terminal 14 to edit music, transmit the music to the on-board device 10 using remote control operation thereof, and then store the music in the on-board device 10. If a web server that provides music is connected to the network 13, the user can operate the operation terminal 14 to download desired music from the web server, and then transmit the music to the on-board device 10 where it is stored. Note that, music may be directly downloaded to the on-board device 10 from the web server. Moreover, in the case that the on-board device 10 is a vehicular video replay device, video data of films or the like can be stored in the on-board device 10 in the same manner as music.

In the case that the on-board device 10 is an engine starter device, the user can operate the operation terminal 14 to remotely operate the on-board device 10, whereby it is possible to start the engine of the vehicle 11. By the time the user gets in to the vehicle 11 and starts driving, the engine of the vehicle 11 is completely warmed up. As a result, it is possible to immediately start driving. Note that if a vehicle heating device or air-conditioning device is also started, a passenger compartment of the vehicle 11 can be placed in a pleasantly warm or cool state by the time the user gets in to the vehicle 11 and starts driving. Accordingly, the user does not feel any sense of discomfort.

In the case that the on-board device 10 is a theft prevention security device, the user can operate the operation terminal 14 to remotely control the on-board device 10 to cause the on-board device 10 to operate or stop. As a result, if the on-board device 10 is turned to OFF immediately prior to when the user gets in to the vehicle 11, there is no need for the troublesome task of canceling security to be executed when getting in to the vehicle 11. Further, when the on-board device 10 is operating, it may be set such that in the case that the vehicle is subject to some sort of act (for example, acts like breaking in to a door or breaking window glass), the on-board device 10 transmits a warning to the operation terminal 14. By doing so, the user in their home can be made immediately aware that the vehicle 11 has been subjected to some sort of act. Note that in the case that a web server of a security protection company, or the like, is connected to the network 13, the on-board device 10 may transmit the warning to the web server of the security protection company, or the like, via the network 13.

The operation terminal 14 may also be a mobile phone device or a PHS phone device that is carried by the user, the external device 12 may be disposed in a pay parking lot at a trip destination (for example, a pay parking lot at a department store or a theme park), and may be connected to a computer that manages the pay parking lot. In this case, in a similar manner to when the vehicle 11 is parked in the parking space at the user's home or nearby to the user's home as previously described, the vehicle 11 may be parked in the pay parking lot. As a result, it is possible to remotely operate the on-board device 10 to cause the on-board device 10 to download map data, music, video data, or the like, or to cause operation of the on-board device 10 to stop. Further, data, managed by the computer, related to the parking time and parking fee of the vehicle 11 may be transmitted to the on-board device 10 from the external device 12.

It is possible for the user to remotely operate the on-board device 10 to transmit data from the on-board device 10 to the mobile phone device or the PHS phone device, acting as the operation terminal 14, via the external device 12. Accordingly, even in the case that the user is away from the vehicle 11, it is possible for the user to ascertain the parking time and the parking fee of the vehicle 11 in real time.

If the computer managing the pay parking lot provides information about various facilities like department stores and theme parks in the vicinity of the pay parking area (for example, data related to internal maps of the facilities, special offers, prize offers, opening times, special events, and the like), the data related to the various facilities may be transmitted to the operation terminal 14 from the on-board device 10 via the external device 12. Accordingly, it is possible for the user to obtain data related to the various facilities in the vicinity of the pay parking lot in real time.

Furthermore, the operation terminal 14 may be a mobile phone device or a PHS phone device that is owned by the user, the external device 12 may be disposed in a parking meter and connected to a computer that manages the parking meter, and the vehicle 11 may be parked in a parking space on a road. In this case, in a similar manner to when the vehicle 11 is parked in the parking space at the user's home or nearby to the user's home as previously described, it is possible to remotely operate the on-board device 10 to cause the on-board device 10 to download map data, music, video data, or the like, or to cause operation of the on-board device 10 to stop. Further, data, managed by the computer, related to the parking time and parking fee of the vehicle 11 may be transmitted to the on-board device 10 from the external device 12.

It is also possible to transmit data from the on-board device 10 to the mobile phone device or the PHS phone device, acting as the operation terminal 14, via the external device 12. Accordingly, even in the case that the user is at a location away from the vehicle 11, it is possible for the user to ascertain the parking time and the parking fee of the vehicle 11 in real time.

If the computer managing the parking meter and the on-board device 10 are provided with an electronic money payment function, an electronic credit payment function, or the like, it is possible for the user to operate operation terminal 14 to remotely control the on-board device 10 and transmit a request to the on-board device 10 to pay additional parking fees. Accordingly, the on-board device 10 pays the additional parking fees by communicating with the computer managing the parking meter and conducting electronic money payment or electronic credit payment. Thus, it is possible for the user to pay additional parking fees even if they are at a location away from the vehicle 11.

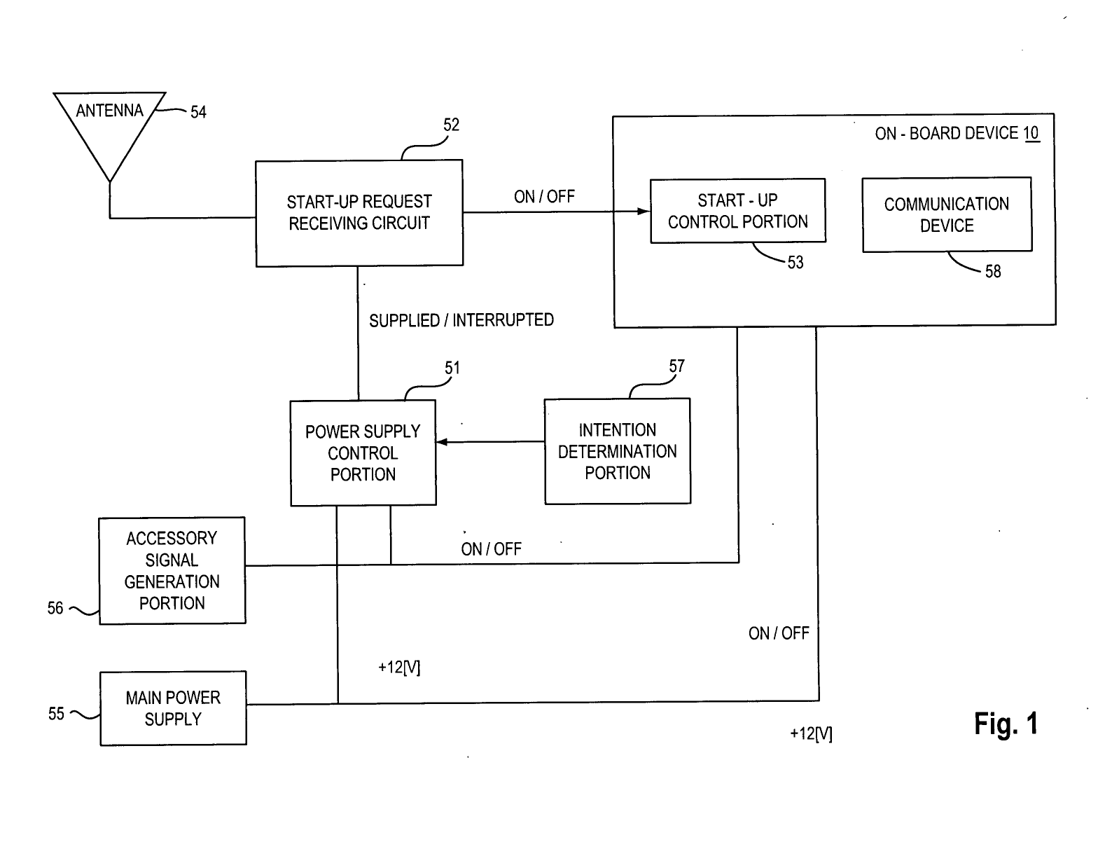

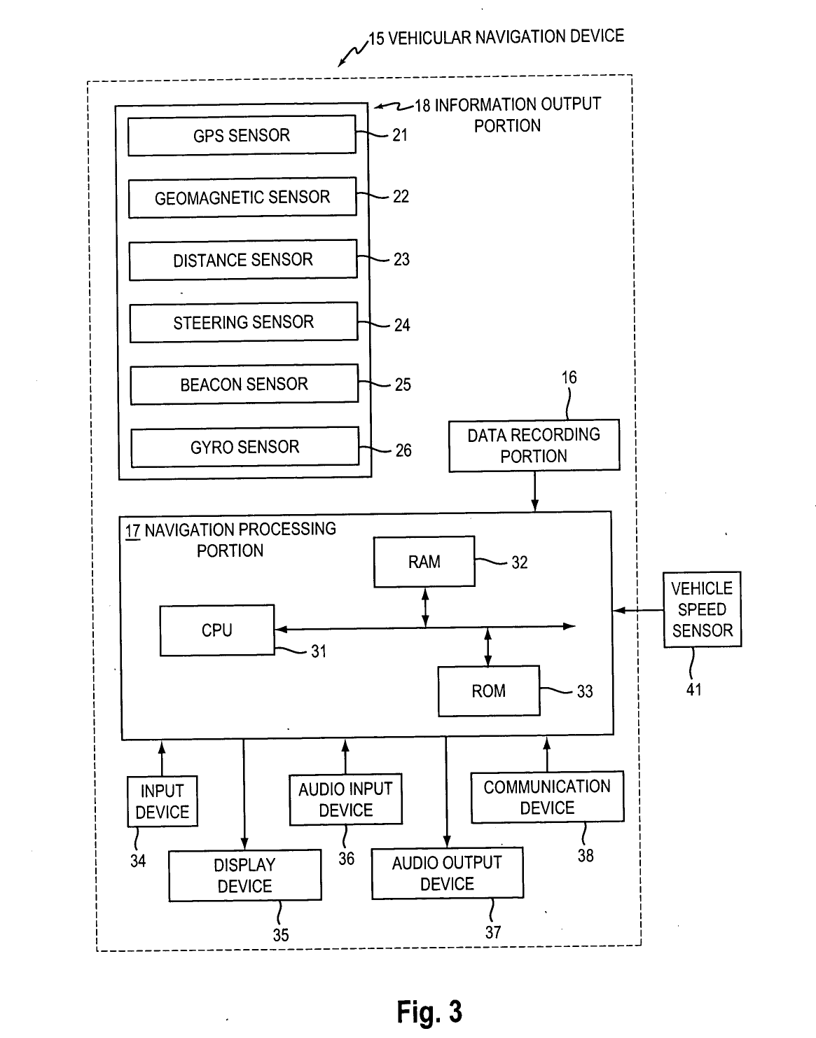

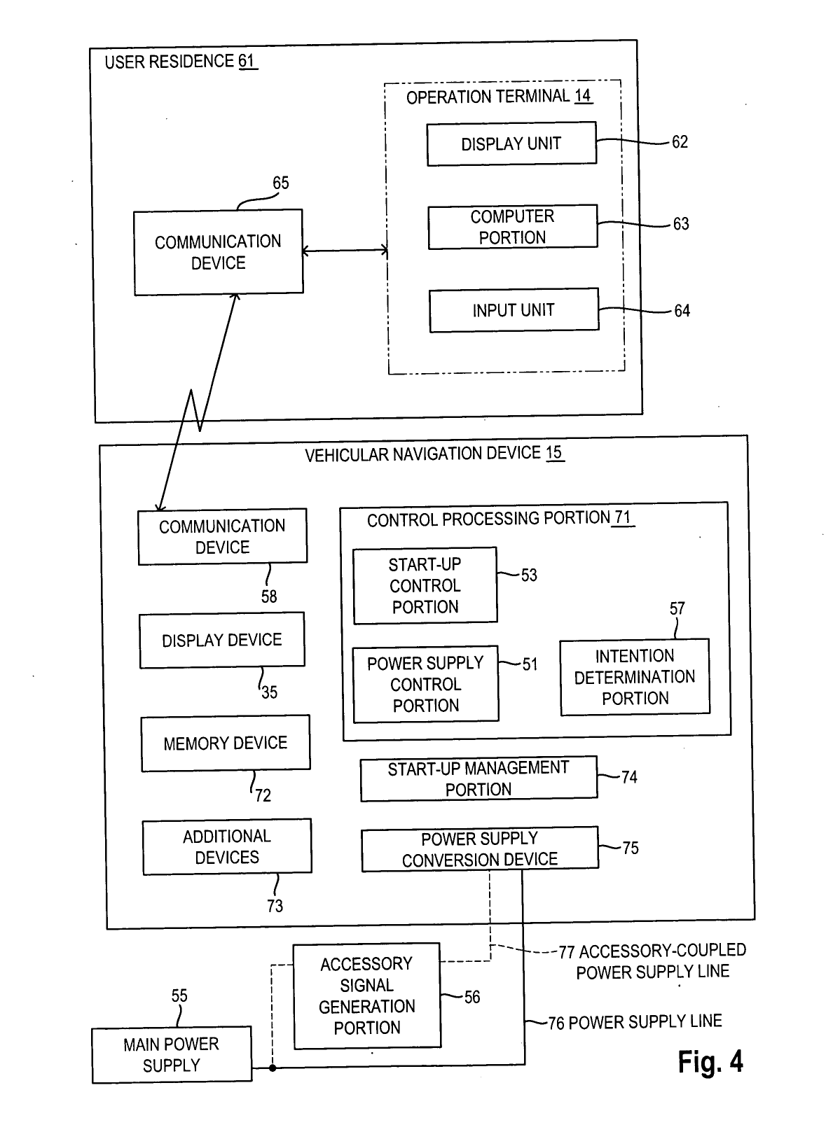

Next, a configuration of a power supply management system for an on-board device of this exemplary embodiment of the invention will be explained with reference to FIGS. 1, 3, and 4. FIG. 1 shows the configuration of the power supply management system for an on-board device according to the first exemplary embodiment of the invention; FIG. 3 shows a configuration of the first exemplary embodiment of the invention when the on-board device is a vehicular navigation device; and FIG. 4 shows a configuration of the power supply management system for an on-board device of the first exemplary embodiment of the invention when the on-board device is the vehicular navigation device.

FIG. 1 shows a power supply control portion 51; a start-up request receiving circuit 52 that acts as a start-up request receiving portion; a start-up control portion 53; an antenna 54; a main power supply 55; an accessory signal generation portion 56; an intention determination portion 57; and a communication device 58.

Note that, when the intention determination portion 57 executes determination as to whether a remote control operation intention of the user exists or not and determines that the remote control operation intention of the user exists, the power supply control portion 51 permits the supply of electric power to the start-up request receiving circuit 52 from the main power supply 55, based on the determination of the intention determination portion 57. In other words, in the case that the intention determination portion 57 determines that there is a remote control operation intention by determining whether the remote control operation intention exits based on settings of the user, the power supply control portion 51 supplies electric power to the start-up request receiving circuit 52. In the case that the intention determination portion 57 determines that the remote control operation intention does not exist, electric power supply to the start-up request receiving circuit 52 is interrupted. Note that an operation of the intention determination portion 57 will be described hereinafter.

The start-up request receiving circuit 52 is a circuit for receiving a start-up request that is received via the antenna 54, and is driven by electric power supplied via the power supply control portion 51. The start-up request is transmitted from the operation terminal 14 via the external device 12, and is a request for causing start-up of the on-board device. The start-up request receiving circuit 52 is configured such that, when a start-up request is received when operation thereof is being executed due to supply of electric power, an ON signal is output. When a start-up request is received when operation thereof is stopped due to interruption of electric power, an OFF signal is output instead of the ON signal.

The start-up control portion 53 controls start-up of, at the least, a portion of the on-board device 10. In other words, the start-up control portion 53 controls the supply of electric power to the on-board device 10 from the main power supply 55 in accordance with an ON signal from the accessory signal generation portion 56. Note that the accessory signal generation portion 56 is, generally, formed integrally with an engine switch of the vehicle 11 such that an ON and OFF operation thereof is executed by the user with an ignition key of the vehicle 11. In addition, when the ON operation of the accessory signal generation portion 56 is executed by the user, the ON signal is output. When the OFF operation thereof is executed, output of the ON signal is cancelled and switching to OFF takes place.

Accordingly, when the start-up control portion 53 receives the ON signal from the accessory signal generation portion 56, it supplies electric power to the on-board device 10. When output of the ON signal is cancelled and switching to OFF takes place, the start-up control portion 53 interrupts electric power supplied to the on-board device 10. Note that the configuration is such that, even if the start-up control portion 53 has not received the ON signal from the accessory signal generation portion 56, when an ON signal is received from the start-up request receiving circuit 52, electric power is supplied to, at the least, a portion of the on-board device 10 and when the output of the ON signal is cancelled and switching to OFF takes place, electric power to the on-board device 10 is interrupted.

The main power supply 55 is generally a vehicle battery. However, it may be a condenser (a capacitor) such as an electric double layer capacitor. Note that a reference value of an open terminal voltage for an inter-terminal voltage of the main power supply 55 may be set to any value. In this exemplary embodiment of the invention, an explanation will be given for the case of a vehicle battery for a compact passenger vehicle which is generally 12V. Further, when an engine, not shown, of the vehicle 11 is operating, an alternator attached to the engine supplies electric power for recharging to the main power supply 55. When the engine is stopped, supply of electric power to the main power supply 55 is stopped and recharging does not take place. When the accessory signal generation portion 56 is OFF, the engine is stopped, whereby supply of electric power from the alternator to the main power supply 55 does not take place and recharging is not executed.

The intention determination portion 57 determines whether or not the remote control operation intention exists based on a condition that is pre-set by the user. In this example, the condition is related to a position, or related to a time/date.

Here, the position is the location of a parking space where the user parks the vehicle 11, and a predetermined area including the location are registered in advance as a registered position area. For example, in the case that the external device 12 is located at the driver's home and the vehicle 11 is parked in a parking space at the user's home or nearby to the user's home, this parking space is the registered position, and a predetermined area including this registered position is registered as the registered position area. Here, in the case that communication between the on-board vehicle 10 and the external device 12 is executed using a wireless system such as a normal wireless LAN, the potential communication area is an area with a radius of about 10 to 100 m around the external device 12. Accordingly, it is preferable that this area is registered as the registered position area. Further, the intention determination portion 57 is configured such that when a present position of the vehicle 11 is within the registered position area, it is determined that the user has the remote control operation intention to execute remote control operation of the on-board device 10 by operating the operation terminal 14. When the present position of the vehicle 11 is outside of the registered position area, it is determined that the user does not have the remote control operation intention.

In the case that the operation terminal 14 is a mobile phone device or a PHS phone device that is carried by the user, the external device 12 is located in a paying parking lot at a trip destination, and the vehicle 11 is parked in this parking lot, it is preferable that a predetermined area including the paying parking lot is registered as the registered position area. Further, in the case that the external device 12 is located in a parking meter and the vehicle 11 is parked in a parking space on a road, a predetermined area including the parking space is registered as the registered position area.

Note that it is possible to both appropriately change the registered position area, and to register a plurality of registered position areas in advance. For example, the area including the parking space at the user's home or nearby their home can be registered as the normal registered position area in advance, and when parking in a parking space on a road, it is possible to register a predetermined area including the parking space in question as the registered position area. When, leaving this parking space, it is possible to cancel registration of the registered position area including the parking space.

In the case that the time/date mentioned above is a time/date when the user executes remote control operation of the on-board device 10 using the operation terminal 14, it is possible to execute setting in accordance with a timetable or schedule of the user. In this case, the user registers the time/date in the on-board device 10 by operating the on-board device 10 or executing transmission from the operation terminal 14. Note that, those days on which there is a high probability of executing remote control operation by operating the operation terminal 14 (for example, the days-off at the end of each week, or the night before each day-off) can be incorporated in advance in a schedule for the time/date. Further, for example, it is possible to set a time period when there is a high probability of executing remote control operation by operating the operation terminal 14 (for example, in the evening), and incorporate this in the schedule in advance. Setting of the time/date like this can easily be executed using, for example, software that manages personal information like PIM (Personal Information Management) for managing timetables and schedules.

Note that, for the time/date, a default (initial setting) may be pre-registered in the on-board device 10 that reflects the usual intentions of the user. For example, in the case that the on-board device 10 is a vehicular navigation device, it can be anticipated that, in preparation for day-off driving, execution of remote control operation of the on-board device 10 for searching in-advance for routes for target destinations will be common. Given this, the evenings before Saturday and Sunday on each weekend, for example, from 6 to 10 pm on Friday and Saturday nights, can be predicted to be time/dates when there is a high probability of remote control operation of the on-board device 10 being executed. Accordingly, the time/dates can be pre-registered in the on-board device 10. Thus, in the case that the user has a conventional work schedule, even if the time/date is not set by the user. him/herself, the intentions of the user can be reflected.

The time/day registered as the default can be changed as appropriate by the user. For example, in the case that the user's days-off are not on the weekend, but on Wednesday and Thursday instead, it is possible to set and register the nights before these days. Moreover, it is possible to appropriately set time periods as well. For example, a mid-night time period can be set and registered. Further, it is possible to set the time/data in correspondence with a special schedule instead of setting a fixed time/date such as the nights before the days-off each week. For example, a user who plans to take a long distance road-trip during the summer vacation can set and register the day/time prior to departure on the long distance road-trip.

The communication device 58 is a device for executing communication with the external device 12, and is, for example, a wireless LAN card, or the like. Note that the communication device 58 functions as a data signal receiving portion, and is configured such that when a data signal is received from outside of the on-board device 10, for example, from the external device 12, the start-up control portion 53 is controlled to start up at least a portion of the on-board device 10.

FIG. 3 shows an on-board device 10 configured as a vehicular navigation device 15. In FIG. 3, the vehicular navigation device is a type of computer. The vehicular navigation device 15, as shown in FIG. 3, has a vehicle position information output portion 18 that outputs vehicle position information by detecting a present position; a data recording portion 16 which records road data, and the like, and which acts as a recording medium; a navigation processing portion 17 that executes various types of calculation processing such as navigation processing, based on input information; an input device 34; a display device 35; an audio input device 36; an audio output device 37 and a communication device 38. A vehicle speed sensor 41 is connected to the navigation processing portion 17.

Further, the vehicle position information output portion 18 is configured from, for example, a GPS (Global Positioning System) sensor 21, a geomagnetic sensor 22, a distance sensor 23, a steering sensor 24, a beacon sensor 25, a gyro sensor 26, and an altimeter (not shown). Note that it is possible to combine or omit, as appropriate, one or more of the GPS sensor 21, the geomagnetic sensor 22, the distance sensor 23, the steering sensor 24, the beacon sensor 25, the gyro sensor 26, the altimeter, due to production cost and/or production resources.

Moreover, the GPS sensor 21 detects the present position on the earth based on reception of a radio wave generated by a man-made satellite; the geomagnetic sensor 22 detects the directional orientation of the vehicle 11 based on measurement of geomagnetism; and the distance sensor 23 detects a distance, etc., from a given position on the road. For the distance sensor 23, for example, it is possible to use a device that estimates a revolution number of the vehicle wheels and detects the distance based on this revolution number; or a device that estimates an acceleration rate and detects the distance by performing double integration of this acceleration rate.

The steering sensor 24 detects a steering angle. For the steering sensor 24, for example, it is possible to use an optical rotation sensor or a rotating resistance sensor attached to a rotating portion of a steering wheel, not shown; or an angle sensor attached to the wheels.

The beacon sensor 25 detects the present position based on reception of position information from beacons provided along the road. The gyro sensor 26 detects a rotational angular velocity of the vehicle 11, namely, a turning angle. For the gyro sensor 26, for example, a gas rate gyro, a vibration gyro, or the like, is used. Moreover, it is possible to detect the directional orientation of the vehicle 11 by integrating the turning angle detected by the gyro sensor 26.

Note that the GPS sensor 21 and the beacon sensor 25 can each independently detect the present position. Further, it is possible to detect the present position by combining the distance detected by the distance sensor 23, and the directional orientation detected by the geomagnetic sensor 22 and the gyro sensor 26. In addition, it is possible to detect the present position by combining the distance detected by the distance sensor 23 and the steering angle detected by the steering sensor 24.

The data recording portion 16 is provided with a data base composed of, for example, map data files, intersection data files, node data files, road data files, photograph data files, and facilities information data files in which facilities information about hotels gasoline stations, and tourist information centers in each region, and the like, is recorded. Moreover, as well as data for searching for routes, various other types of data for display on a screen of the display device 35 are recorded in the data recording portion 16, such as guidance maps for along the established route; photographs, split screen maps, and the like, that show intersections or key features along the route; distances to upcoming intersections and direction of travel at upcoming intersections; and other guidance information. Note that various types of data for outputting predetermined information using the voice output device 37 are also recorded in the data recording portion 16.

It should be noted that intersection data, node data, and road data may be respectively recorded in the intersection data files, the node data files, and road data files. Road conditions may be displayed on the screen using the intersection data, the node data and the road data. Further, the intersection data may include the type of the intersection, namely, whether the intersection has traffic lights, or whether the intersection does not have traffic lights. The node data includes, at the least, the positions and shapes of the roads of the map data recorded in the map data files, and is comprised of data that shows branch points of actual roads (including intersections, T-junctions, and the like), node points, and links that connect each of the node points. In addition, the node points, at the least, indicate the position of bends in the roads.

The road data includes data about the road itself, namely, road width, gradient, cant, altitude, bank, the state of the road surface, the number of road lanes, points where the number of road lanes reduces, points where the width of the road narrows, and the like. Note that, in the case of a highway or a arterial road, lanes on opposing sides are stored respectively as separate road data, and processed as two separate roads. For example, in the case of an arterial road with two lanes or more on each side, it is processed as two separate roads and stored in the road data as to independent roads, i.e., one road for the upstream lane and one road for the downstream lane. Further, with regard to corners, data is included such as curve radius, intersections, T-junctions, and corner entry points. Further, with regard to road attributes, data is included such as railway crossings, highway entry-exit ramp ways, highway toll-collection booths, downward sloping roads, upward sloping roads, and road type (for example, national arterial road, primary road, local road, express highway).

The navigation processing portion 17 may be configured from a CPU 31 that executes overall control of the vehicular navigation device 15; a RAM 32 used as working memory for occasions when the CPU 31 executes various types of calculation processing; and a ROM 33 that acts as a storage medium and on which control programs, as well as various types of program for executing destination route searches, drive-guidance along the route, determination of specified areas, search for locations and facilities, and the like are stored.

The navigation processing portion 17 is connected to the input device 34, the display device 35, the audio input device 36, the audio output device 37, and the communication portion 38. Route searches, route guidance, determination of specific areas, searches for locations, facilities, and the like, are executed. Note that one or more of the audio input device 36, the audio output device 37 and the communication device 38 may be combined or omitted depending on manufacturing cost and/or manufacturing resources.

The storage media within the vehicular navigation device 15, which are computer-readable and on which the navigation programs are stored are not limited to being a semi-conductor memory, and may be any form of storage medium such as a magnetic tape, a magnetic disk, a magnetic drum, a CD-R/W, an MD, a DVD-RAM, an optical disk, an MO, an IC card, an optical card, or a memory card.

The data recording portion 16 and the ROM 33 are configured from a magnetic core, a semi-conductor memory, or the like, not shown. Further, the data recording portion 16 and the ROM 33 can use any type of storage medium such as a magnetic tape, a magnetic disk, a magnetic drum, a CD-RWW, an MD, a DVD-RAM, an optical disk, an MO, an IC card, an optical card, or a memory card. The storage medium may be installed in advance in the vehicular navigation device 15, and can be replaced as appropriate by the user.

According to this exemplary embodiment, various programs are stored in the ROM 33, and various types of data are stored in the date recording portion 16. However, the programs and the data can be stored in the same manner in an external storage medium. In this case, for example, a storage medium like a flash memory, or the like, not shown, is provided in the navigation processing portion 17, whereby it is possible to read the programs and the data from the external storage medium and write them on the storage medium. Accordingly, it is possible to update the programs and the data by replacing the external storage medium. In this manner, it is possible to start up the various programs stored on the storage medium and execute various types of processing based on the data. Note that, the external storage medium may be of any type, such as, for example, a magnetic tape, a magnetic disk, a magnetic drum, a CD-R/W, an MD, a DVD-RAM, an optical disk, an MO, an IC card, an optical card, or a memory card.

The communication device 38 executes communication with the network 13 and the operation terminal 14 via the external device 12. For example, it is possible for various types of data to be received, such as road information about congestion, and the like, received from an information sensor, or the like, not shown; traffic accident information; and D-GPS information that detects a detection difference (error) of the GPS sensor 21. According to this exemplary embodiment, when at least a part of the programs and data transmitted from the web server, which is connected to the network 13 and which provides latest-version map data and programs, is received, the CPU 31 can execute downloading to a readable/writeable memory, such as a storage medium which may be the RAM 32, a flash memory, a hard disk, or the like, and then start up the programs and execute various types of processing based on the data.

Further, it is possible to use the operation terminal 14 to download programs, data, and the like, transmitted from the web server to a storage medium such as a memory card or a CD-R that can be removed from a personal computer, and then start-up the programs and execute various types of processing based on this data.

The input device 34 is used to correct the vehicle position when driving starts, input the target destination, and the like, and is configured from an operation key, a push button, a jog dial, a cross-shaped switch-key, or the like, that is provided on a body of the vehicular navigation device 15. However, it may also be a remote controller. Further, in the case that the display device 35 has a touch panel, it is preferable that it is configured from an operation switch like an operation key or an operation menu that is displayed on the screen of the display device 35. In this case, in the same manner as a conventional touch panel, it is possible to execute input by pushing (touching) the operation switch.

Further, operation guidance, an operation menu, guidance about the operation key, the route from the present position to the target destination, guidance information along the route, and the like, are displayed on the screen of the display device 35. For the display device 35, it is possible to use, for example, a CRT display, a liquid crystal display, an LED display, a plasma display, a hologram device which projects a hologram on to a windshield.

The audio input device 36 is configured from a microphone, or the like, not shown, and makes it possible to input necessary information by voice. Further, the audio output device 37 is provided with a voice synthesis device and a speaker, not shown, and provides the user with audio information by using the speaker to output, for example, guidance information and speed shift information, which is generated by a voice that is synthesized by the voice synthesis device. Note that, as well as the voice synthesized by the voice synthesis device, the speaker may be used to output various types of sounds, and various types of guidance information that are pre-recorded on a tape, a memory, or the like.

FIG. 4 shows the configuration of the power supply management system for an on-board device when the on-board device 10 is the vehicular navigation device 15. In this example, the vehicle 11 is parked in a parking space at a user residence 61, which is assumed to be the user's home. Further, the operation terminal 14 used by the user is provided with a display unit 62 such as a CRT, a liquid crystal display, or an LED display; a computer portion 63 which includes a calculation unit such as a CPU or MPU and a storage unit such as a semi-conductor memory or a magnetic disk, and which executes computer processing; and an input unit 64 such as a keyboard, a joy-stick, a touch panel, a tablet, a push button, a rotating dial or a remote controller. In addition, in the case that the input unit 64 is a touch panel or a tablet, it is configured integrally with the display unit 62.

The communication device 65, which includes the external device 12 connected to the operation terminal 14 via the network 13 (FIG. 2), is disposed in the user residence 61 and wirelessly executes communication with the communication device 58 of the vehicular navigation device 15. Note that a communication-capable area of the communication device 65 is an area with a radius of around 10 to 100 m, and this area is set to be the registered position area.

Further, for the purposes of a power supply management function, the vehicular navigation device 15 is provided with, as shown in FIG. 4, a control processing portion 71, a start-up management portion 74, a power supply conversion device 75, a communication device 58, a display device 35, a memory device 72, and additional devices 73. The control processing portion 71 has an integrated control processing function for the operation of the vehicular navigation device 15, and is provided with the power supply control portion 51, the start-up control portion 53 and the intention determination portion 57. The start-up management portion 74 executes management related to which portions of the vehicular navigation device 15 need to be provided with electric power, and supplies electric power to devices that need to be started up, and interrupts supply of electric power to devices to be stopped. Note that, electric power supplied from the main power supply 55, such as the vehicle battery, has its voltage, or the like, converted by the power supply conversion device 75, and this is then supplied to the device that needs to be started up. In this case, electric power supplied from the main power supply 55 is always supplied to the power supply conversion device 75 via a power supply line 76, and is also supplied, while subject to ON-OFF control of the accessory signal generation portion accessory signal generation portion 56, to the power supply conversion device 75 via an accessory-coupled power supply line 77.

The memory device 72 is provided with all of the storage units and recording units, including the RAM 32, the ROM 33 and the date recording portion 16, shown in FIG. 3, and is not only a semi-conductor memory, but includes any form of storage medium such as a magnetic tape, a magnetic disk, a magnetic drum, a CD-R/W, an MD, a DVD-RAM, an optical disk, an MO, an IC card, an optical card, or a memory card. Further, the additional devices 73 include, for example, the vehicle position information output portion 18, the vehicle speed sensor 41, the input device 34, the audio input device 36, the audio output device 37, the communication device 38, and the start-up request receiving circuit 52, shown in FIG. 3.

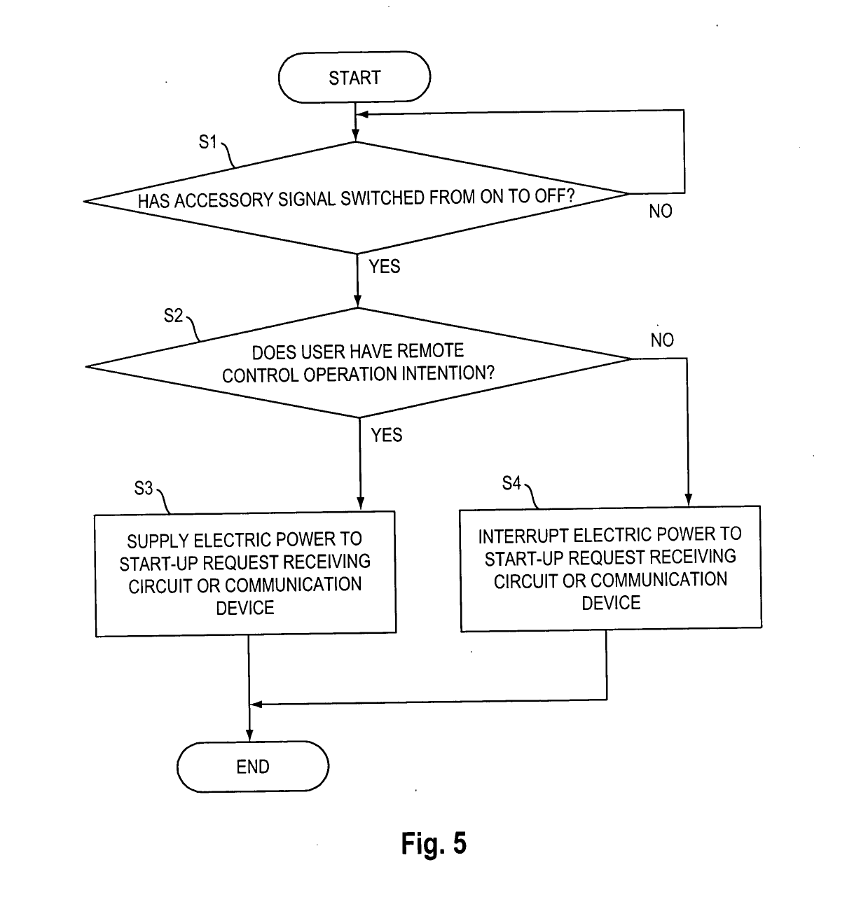

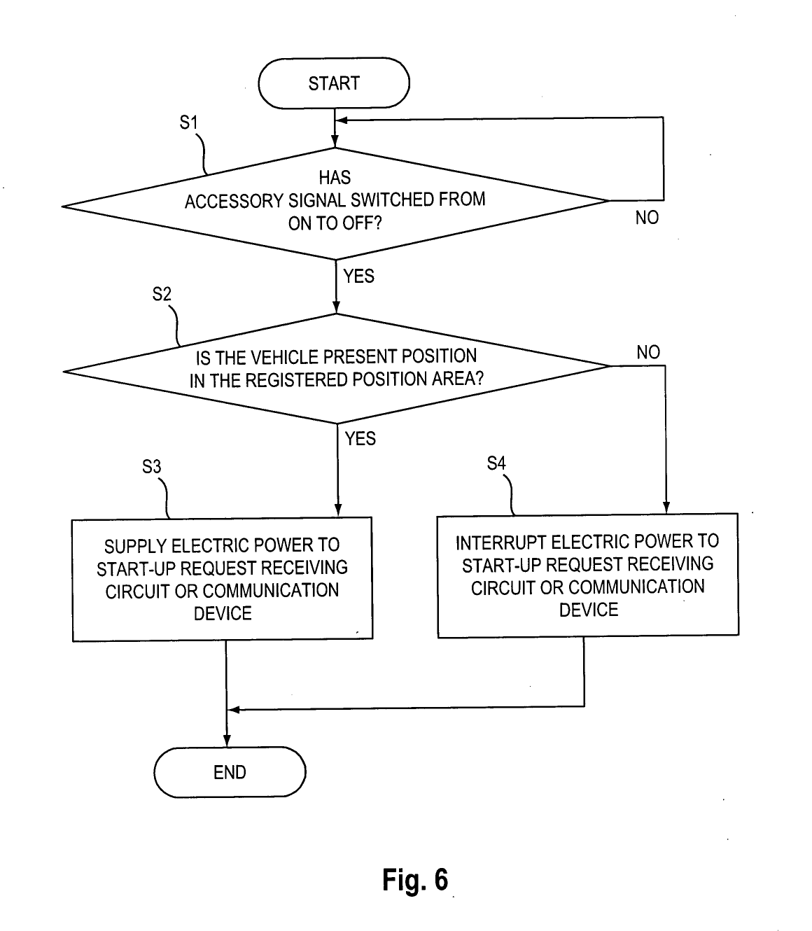

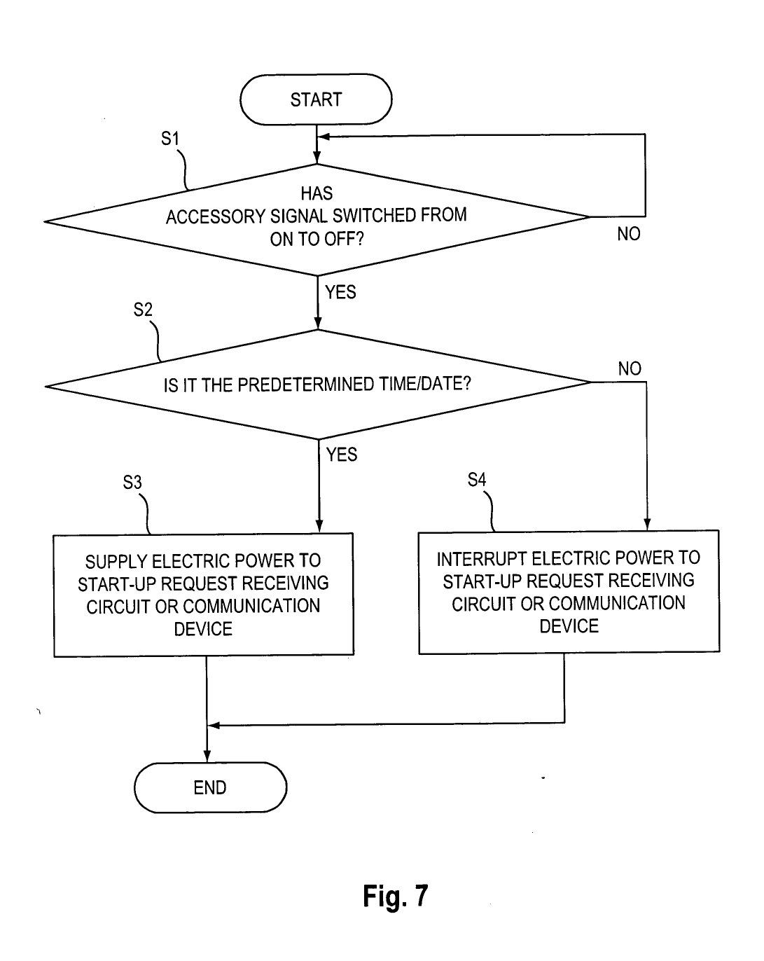

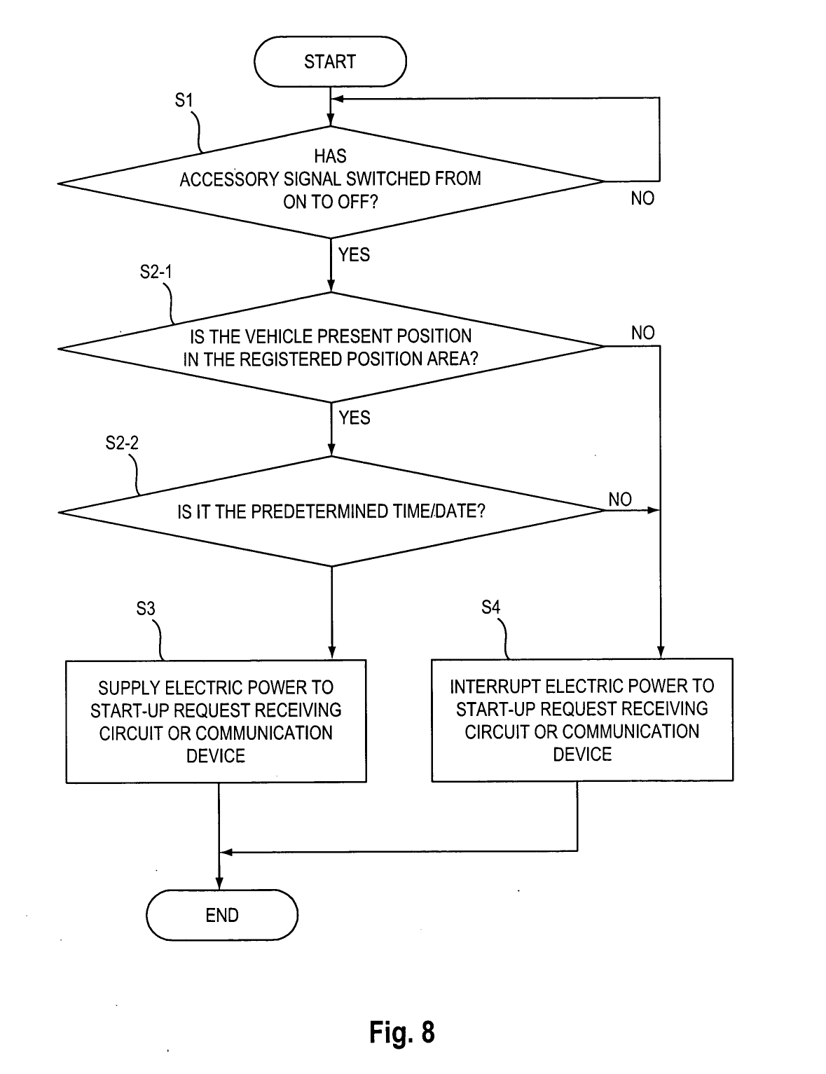

Next, an operation of the power supply management system for an on-board device with the above configuration will be described with reference to FIGS. 5-8. FIG. 5 is a flow chart showing the operation of the power supply management system for an on-board device of the first exemplary embodiment of the invention; FIG. 6 is a flow chart showing an operation of the power supply management system for an on-board device of the first exemplary embodiment of the invention when the condition set by the user is the position; FIG. 7 is a flow chart showing an operation of the power supply management system for an on-board device of the first exemplary embodiment of the invention when the condition set by the user is the time/date; and FIG. 8 is a flow chart showing an operation of the power supply control portion of the first exemplary embodiment of the invention when the condition set by the user is the position and the time/date.

Note that an explanation will be given here for a case where data is transferred to the on-board device 10 from the operation terminal 14 while the vehicle 11 is parked in the parking space at the user's home.

First, the control processing portion 71 determines whether the accessory signal of the accessory signal generation portion 56 has switched from ON to OFF. If the accessory signal is switched on ON, the determination is repeatedly executed. On the other hand, if it is determined that the accessory signal is switched OFF, the intention determination portion 57 determines whether or not the user has the intention to execute remote control operation of the on-board device 10 by operating the operation terminal 14. If the intention determination portion 57 determines that the user has the remote control operation intention, the power supply control portion 51 supplies electric power to the start-up request receiving circuit 52 or the communication device 58. On the other hand, if the intention determination portion 57 determines that the user does not have the remote control operation intention, the power supply control portion 51 interrupts supply of electric power to the start-up request receiving circuit 52 or the communication device 58.

The above-described process is summarized in the flow chart of FIG. 5. As shown in FIG. 5, in step SI it is determined whether the accessory signal has switched from ON to OFF. If switching to OFF has been executed, operation continues to step S2. If switching to OFF has not been executed, operation returns to step S1. Then, in step S2, it is determined whether the user has the remote control operation intention. If the user has the remote control operation intention, operation continues to step S3. If the user does not have the remote control operation intention, operation jumps to step S4. In step S3, electric power is supplied to the start-up request receiving circuit 52 or the communication device 58. In step S4, supply of electric power to the start-up request receiving circuit 52 or the communication device 58 is interrupted.

As discussed above, one condition by which the intention determination portion 57 determines whether the user has the remote control operation intention is the position. Accordingly, the intention determination portion 57 determines whether the present position of the vehicle 11 is within the registered position area. Note that the registered position area is the communication-capable area of the communication device 65 disposed in the user residence 61. In addition, when the present position of the vehicle 11 is within the registered position area, the intention determination portion 57 determines that the user has the remote control operation intention, and thus the power supply control portion 51 supplies electric power to the start-up request receiving circuit 52 or the communication device 58.

The above-described process is summarized in the flow chart shown in FIG. 6. As shown in FIG. 6, in step SI, it is determined whether the accessory signal has switched from ON to OFF. If switching to OFF has been executed, operation continues to step S2-1. If switching to OFF has not been executed, operation returns to step S1. Then, in step S2-1, it is determined whether the present position of the vehicle is within the registered position area. In the case that it is within the registered position area, operation continues to step S3. In the case it is not within the registered position area, operation jumps to step S4. In step S3, electric power is supplied to the start-up request receiving circuit 52 or the communication device 58. In step S4, supply of electric power to the start-up request receiving circuit 52 or the communication device 58 is interrupted.

On the other hand, a condition by which the intention determination portion 57 determines whether the user has the remote control operation intention may be the time/date. As such, the intention determination portion 57 determines whether the present time is a predetermined time/data, based on a clock (not shown) provided in the on-board device 10. Note that the predetermined time/date is a time that is pre-set by the user, such as a determined time period on Saturday, like 8 to 10 pm. Next, when it is the predetermined time/date, the intention determination portion 57 determines that the user has the remote control operation intention, and thus the power supply control portion 51 supplies electric power to the start-up request receiving circuit 52 or the communication device 58. Further, in the case that it is not the predetermined time/date, the intention determination portion 57 determines that the user does not have the remote control operation intention, and thus the power supply control portion 51 interrupts the supply of electric power to the start-up request receiving circuit 52 or the communication device 58.

The above-described process is summarized in the flow chart shown in FIG. 7. As shown in FIG. 7, in step SI it is determined whether the accessory signal has switched from ON to OFF. If switching to OFF has been executed, operation continues to step S2-2. If switching to OFF has not been executed, operation returns to step S1. Then, in step S2-2, it is determined whether it is the predetermined time/date. If it is the predetermined time/date, operation continues to step S3. If it is not the predetermined time/date, operation jumps to step S4. In step S3, electric power is supplied to the start-up request receiving circuit 52 or the communication device 58. In step S4, supply of electric power to the start-up request receiving circuit 52 or the communication device 58 is interrupted.

The condition by which the intention determination portion 57 determines whether the user has the remote control operation intention may be the position and the time/date. As such, the intention determination portion 57 determines whether the present position of the vehicle 11 is within the registered position area. In the case that it is within the registered position area, next, the intention determination portion 57 determines whether the present time is the predetermined time/data. Note that in the case that the present position of the vehicle 11 is not within the registered position area, the intention determination portion 57 determines that the user does not have the remote control operation intention, and thus the power supply control portion 51 interrupts the supply of electric power to the start-up request receiving circuit 52 or the communication device 58. In addition, in the case that it is determined that it is the predetermined time/date, the intention determination portion 57 determines that the user has the remote control operation intention. Accordingly, the power supply control portion 51 supplies electric power to the start-up request receiving circuit 52 or the communication device 58. Further, in the case that it is not the predetermined time/date, the intention determination portion 57 determines that the user does not have the remote control operation intention, and thus the power supply control portion 51 interrupts the supply of electric power to the start-up request receiving circuit 52 or the communication device 58.

The above-described process is summarized in the flow chart of FIG. 8. As shown in FIG. 8, in step SI it is determined whether the accessory signal has switched from ON to OFF. If switching to OFF has been executed, operation continues to step S2-1. If switching to OFF has not been executed, operation returns to step S1. Then, in step S2-1, it is determined whether the present position of the vehicle is within the registered position area. If the vehicle is within the registered position area, operation continues to step S2-2. If the vehicle is not within the registered position area, operation jumps to step S4.

Next, in step S2-2, it is determined whether it is the predetermined time/date. If it is the predetermined time/date, operation continues to step S3. If it is not the predetermined time/date, operation jumps to step S4. In step S3, electric power is supplied to the start-up request receiving circuit 52 or the communication device 58. In step S4, supply of electric power to the start-up request receiving circuit 52 or the communication device 58 is interrupted.

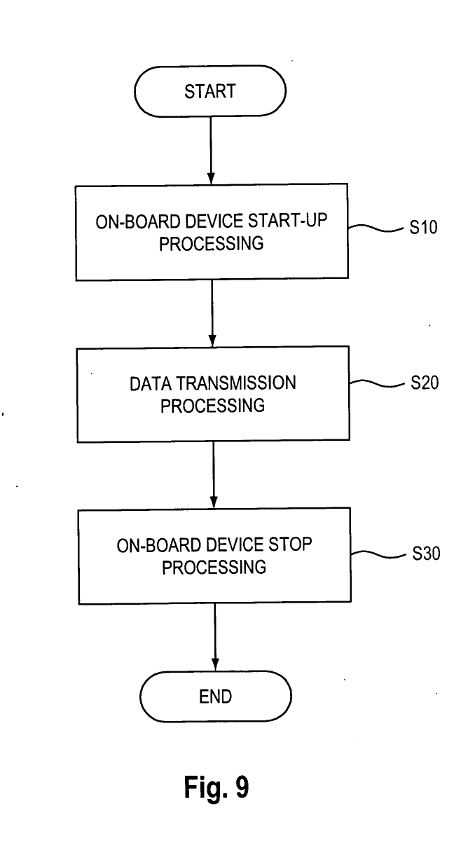

Next, an explanation will be given for the case when, in the power supply management system for an on-board device 10, the power supply control portion 51 supplies electric power to the start-up request receiving circuit 52 with reference to FIG. 9. In this case, on-board device start-up processing is executed, then data transmission processing is executed, and following this, on-board device stop processing is executed.

During the on-board device start-up processing, first, a start-up request is transmitted to the on-board device 10 from the operation terminal 14 via the external device 12. The start-up request includes an ID that specifies the on-board device 10. The on-board device 10 then transmits a reception confirmation to the operation terminal 14 that confirms reception of the start-up request via the external device 12. Note that, when the operation terminal 14 does not receive the reception confirmation after a predetermined time has elapsed following transmission of the start-up request, it transmits the start-up request repeatedly up to, for example, three times.

Next, start-up processing is executed so as to start-up the on-board device 10. Then, the on-board device 10 transmits a start-up processing completed notification that indicates the completion of start-up processing to the operation terminal 14 via the external device 12. The operation terminal 14 then transmits a reception confirmation that confirms reception of the start-up processing completed notification to the on-board device 10 via the on-board device 12. Note that, when the on-board device 10 does not receive the reception confirmation after a predetermined time has elapsed following transmission of the start-up completed notification, it transmits the start-up completed notification repeatedly up to, for example, three times.

Next, in the data transmission processing, a user ID for verification of the user is transmitted to the on-board device 10 from the operation terminal 14 via the external device 12. A password may also be transmitted along with the user ID. Then, the on-board device 10 transmits a reception confirmation that confirms reception of the user ID to the operation terminal 14 via the external device 12. Note that, when the operation terminal 14 does not receive the reception confirmation after a predetermined time has elapsed following transmission of the user ID, it transmits the user ID repeatedly up to, for example, three times.

Next, verification processing is executed in the on-board device 10 based on the user ID and the password. Then, the on-board device 10 transmits an indication that the verification processing is completed to the operation terminal 14 via the external device 12. The operation terminal 14 transmits a reception confirmation that confirms reception of the verification to the on-board device 10 via the external device 12. Note that, when the on-board device 10 does not receive the reception confirmation after a predetermined time has elapsed following transmission of the verification OK, it transmits the verification OK repeatedly up to, for example, three times.

Then, a transmission start request is transmitted from the operation terminal 14 to the on-board device 10 via the external device 12. The on-board device 10 transmits a reception confirmation that confirms reception of the transmission start request to the operation terminal 14 via the external device 12. Note that, when the operation terminal 14 does not receive the reception confirmation after a predetermined time has elapsed following transmission of the transmission start request, it transmits the transmission start request repeatedly up to, for example, three times. Then, data is transmitted from the operation terminal 14 to the on-board device 10 via the external device 12.

When transmission of the data is completed, an indication that the transmission is completed is transmitted from the operation terminal 14 to the on-board device 10 via the external device 12. Then, the on-board device 10 transmits a reception confirmation that confirms reception of the transmission complete transmission to the operation terminal 14 via the external device 12.

Finally, in the on-board device stop processing, a stop request is transmitted from the operation terminal 14 to the on-board device 10 via the external device 12. The stop request includes an ID that specifies the on-board device 10. Next, the on-board device 10 transmits a reception confirmation that confirms reception of the stop request to the operation terminal 14 via the external device 12. Note that, when the operation terminal 14 does not receive the reception confirmation after a predetermined time has elapsed following transmission of the stop request, it transmits the stop request repeatedly up to, for example, three times.

Then, the on-board device 10 transmits a stop completed notification to the operation terminal 14 via the external device 12. The operation terminal 14 transmits a reception confirmation that confirms reception of the stop completed notification to the on-board device 10 via the external device 12. Note that, when the on-board device 10 does not receive the reception confirmation after a predetermined time has elapsed following transmission of the stop completed notification, it transmits the stop completed nonfiction repeatedly up to, for example, three times. Lastly, the on-board device stop processing is executed so as to stop the on-board device 10.

The above-described process is summarized in the flow chart shown in FIG. 9. As shown in FIG. 9, in step S10, the on-board device start-up processing is executed. Then, in step S20, the data transmission processing is executed. Next, in step S30, the on-board device stop processing is executed.

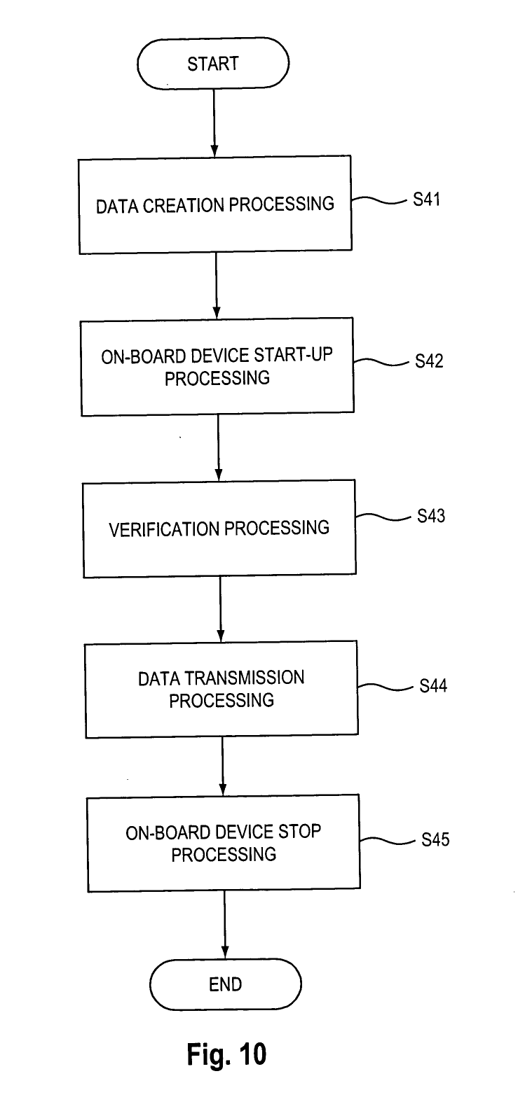

An operation when the on-board device start-up processing is executed by specific low-power wireless, and when the data transmission processing is executed by wireless LAN will be explained with reference to FIG. 10.

The explanation assumes that a web site is accessed and a search for a route to a target destination is executed. Then, data that is created in relationship to an established route is transmitted to the on-board device 10. According to this example, the user operates the operation terminal 14 to access a web server, not shown, and then logs-in to a predetermined web site supported by the web server. The web site provides a service that allows a route to a target destination to be searched for by executing navigation processing. Further, the web site may be provided with a user dedicated area. If the user inputs a user name, password, and the like, they are able to log-in to the area. Then, when the user inputs search conditions such as a departure location and a target destination, the route to the target destination is searched for and data for guidance along the route is created. Following this, the user downloads the created data to the operation terminal 14. With this, the data creation processing is completed.

Next, the user operates the operation terminal 14 to transmit the downloaded data to the on-board device 10. In this case, the start-up request is transmitted to the on-board device 10 from the external device 12. In addition, when the on-board device 10 receives the start-up request, the on-board device start-up processing is executed in order to perform start-up. With this, the on-board device start-up processing is completed, and a wireless LAN card that acts as the communication device 58 of the on-board device 10 transmits the user ID to the external device 12 that functions as an access point. The external device 12, upon receipt of the user ID, transmits a reception confirmation to the communication device 58, and executes verification processing of the communication device 58. The external device 12 transmits a verification that indicates the completion of the verification processing to the communication device 58. Then, the communication device 58 transmits a reception confirmation that confirms receipt of the verification OK to the external device 12. With this, the verification processing is completed.

Next, following transmission of the data to the on-board device 10 from the operation terminal 14 via the external device 12, the on-board device 10 stores the received data. With this, the data transmission processing is completed. Lastly, in the on-board device start-up processing, a stop request is transmitted from the operation terminal 14 to the on-board device 10 via the external device 12, whereby the on-board device 10 is stopped by execution of the on-board device start-up processing.

The above-described process is summarized in the flow chart of FIG. 10. As shown in FIG. 10, in step S41, the data creation processing is executed. Then, in step S42, the on-board device start-up processing is executed. Next, in step S43, the verification processing is executed. In step S44, the data transmission processing is executed. In step S45, the on-board device stop processing is executed.

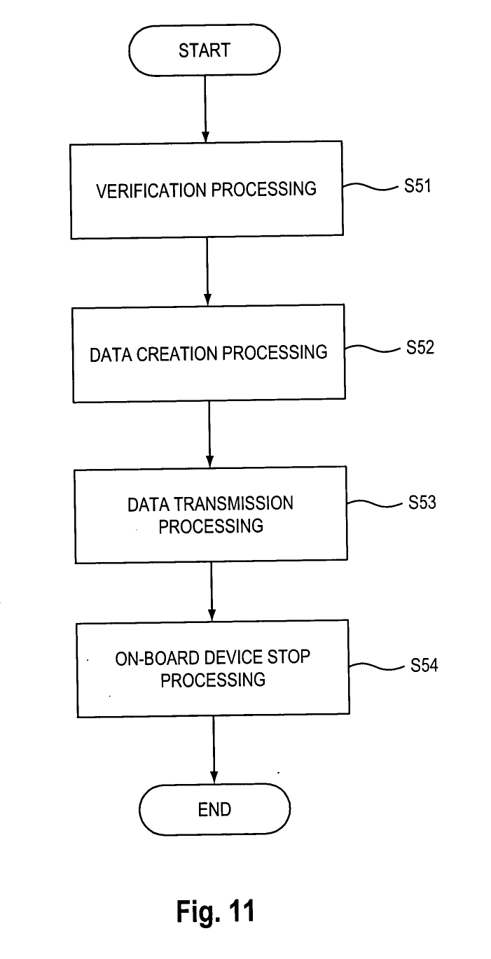

Next, an operation when the on-board device start-up processing is executed by wireless LAN, and when the data transmission processing is executed by wireless LAN will be explained with reference to FIG. 11.

First, a web site is accessed and a search for a route to a target destination is executed. Data that is created in relationship to an established route is transmitted to the on-board device 10. In this example, the wireless LAN card that acts as the communication device 58 of the on-board device 10 transmits the user ID to the external device 12 that functions as the access point. Then, the external device 12, upon receipt of the user ID, transmits a reception confirmation to the communication device 58, and executes verification processing of the communication device 58. The external device 12 transmits a verification that indicates the completion of the verification processing to the communication device 58. Then, the communication device 58 transmits a reception confirmation that confirms receipt of the verification to the external device 12. With this, the verification processing is completed.

The user operates the operation terminal 14 to access the web server (not shown) and then logs-in to the predetermined web site supported by the web server. The web site provides a service that allows a route to a target destination to be searched for by executing navigation processing. The web site may also be provided with the user dedicated area. If the user inputs a user name, password, and the like, they are able to log-in to the area. Then, when the user inputs search conditions such as a departure location and a target destination, the route to the target destination is searched for and data for guidance along the route is created. Following this, the user downloads the created data to the operation terminal 14. As a result, the data creation processing is completed.

The user then operates the operation terminal 14 so as to transmit the data to the on-board device 10. In this case, when the data is transmitted to the on-board device 10 from the operation terminal 14 via the external device 12, a predetermined portion of the on-board device 10 starts up. Then, the on-board device 10 stores the received data. With this, the data transmission processing is completed. Lastly in the on-board device start-up processing, a stop request is transmitted from the operation terminal 14 to the on-board device 10 via the external device 12, whereby the on-board device 10 is stopped by execution of the on-board device start-up processing.

The above-described process is summarized in the flow chart of FIG. 11. As shown in FIG. 11, in step S51, the verification processing is executed. Then, in step S52, the data creation processing is executed. Next, in step S53, the data transmission processing is executed. In step S54, the on-board device stop processing is executed.

Therefore, according to this exemplary embodiment, when the intention determination portion 57 determines that the user has the remote control operation intention, electric power is supplied to the start-up request receiving circuit 52 or the communication device 58. In this example, the intention determination portion 57 executes determination as to whether the remote control operation intention exists based upon the conditions related to the position and/or the time/date that is pre-set by the user. In addition, in the case that the condition relates to the position, the configuration is such that the intention determination portion 57 determines that, when the present position of the vehicle 11 is within the registered position area, the user has the remote control operation intention to execute remote control operation of the on-board device 10 by operating the operation terminal 14 and determines that, when the present position of the vehicle 11 is outside of the registered position area, that the user does not have the remote control operation intention.

In the case that the condition is related to the time/date, the configuration is such that the intention determination portion 57 determines that, when it is the predetermined time/date, that the user has the remote control operation intention to execute remote control operation of the on-board device 10 by operating the operation terminal 14 and determines that, when it is not the predetermined time/date, that the user does not have the remote control operation intention.

Accordingly, when the vehicle 11 is parked within the registered position area or when it is the predetermined time/date, or both, the start-up request receiving circuit 52 is driven by electric power supplied thereto, and when the start-up request receiving circuit 52 receives the start-up request transmitted from the external device 12, the start-up control portion 53 is controlled so as to start up, at the least, a portion of the on-board device 10. The communication device 58 is driven by electric power supplied thereto, and when it receives the data signal transmitted from the external device 12, the start-up control portion 53 is controlled so as to start up, at the least, a portion of the on-board device 10.

Here, the portion of the on-board device 10 that is started up by the start-up control portion 53 is, for example, (in the case that the data is downloaded to the on-board device 10 and stored on a magnetic disk acting as a hard disk that is provided as the storage unit of the on-board device 10), the hard disk, the RAM acting as a semi-conductor body provided as the storage unit of the on-board device 10, and the CPU provides as the calculating unit thereof; further, for example, when the downloaded data is stored in the RAM, it is the RAM and the CPU, or the RAM alone.

In addition, the configuration is such that, when the vehicle 11 is parked outside of the registered position area or when it is not the predetermined time/date, the supply of electric power to the start-up request receiving circuit 52 and the communication device 58 is interrupted.

As a result, when the vehicle 11 is parked at a location away from the predetermined area, or when it is not the predetermined time/date, it is possible to interrupt the supply of electric power to the start-up request receiving circuit 52 and the communication device 58. As a result, it is possible to inhibit discharge of the vehicle battery that acts as the main power supply 55. Further, when the vehicle 11 is parked at the predetermined area or when it is the predetermined time/date, it is possible for the user to operate the operation terminal 14, whereby it is possible for the on-board device 10 to be operated by remote control operation, data to be transmitted to the on-board device 10, and so on.

Accordingly, when the vehicle 11 is parked with the engine stopped, except for when the intention determination portion 57 determines that the user has the remote control operation intention to execute remote control operation of the on-board device 10, it is possible to interrupt the supply of electric power to the on-board device 10, whereby it is possible to reduce discharge of the vehicle battery acting as the main power supply 55.

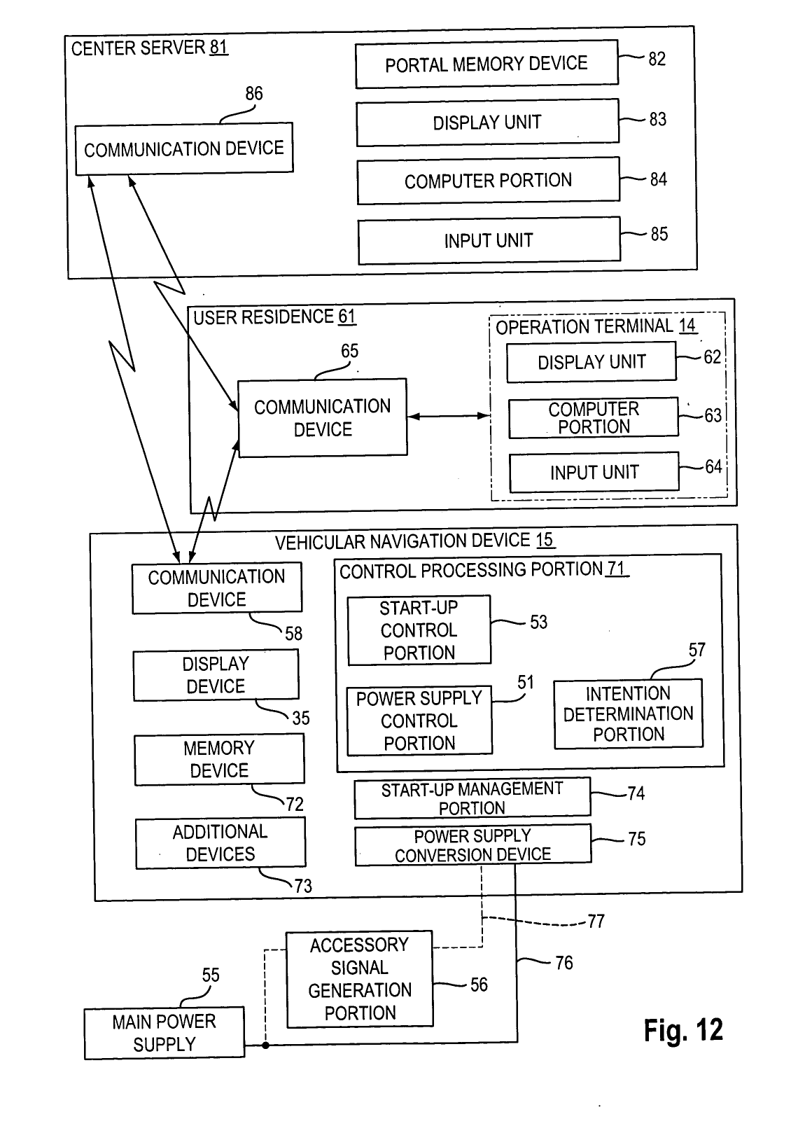

A second exemplary embodiment of the invention will be explained with reference to FIG. 12. Note that structural members that are the same as those of the first exemplary embodiment are denoted with the same reference numerals, and an explanation thereof is omitted. Further, an explanation of operations and effects that are the same as those of the first embodiment is also omitted.

FIG. 12 shows a configuration of a power supply management system for an on-board device of the second embodiment of the invention. As shown in FIG. 12, reference numeral 81 denotes a-center sever disposed at an information center that provides various types of information, and is connected to the communication device 65 of the user residence 61 via the network 13 (FIG. 2) of the Internet, or the like (that was explained for the first embodiment), such that communication therebetween is possible. The center server 81 that is a type of computer provided with, for example, a calculation unit, such as a CPU or MPU; a storage unit, such as a semi-conductor memory or a magnetic disk; a display unit, such as a CRT, a liquid crystal display, or an LED display; an input unit, such as a keyboard, a touch panel, a tablet, a push button, or a mouse; and an input-output interface. In addition, although the center server 81 is, for example, a web server connected to the Internet, it may be another type of device such as a personal computer, or a work station. Moreover, the center server 81 may be configured so as to be independent, may be a distributed server that connects a plurality of servers, or may be one system configured within a large computer.

The center server 81 distributes, via the network 13, navigation data used by the vehicular navigation device 15, such as map data, road data, photographic data and facilities information data including information about facilities such as hotels, gasoline stations and tourist information centers in each region; update programs for the vehicular navigation device 15; software for personal information management that can be utilized by the vehicular navigation device 15; data for the user's schedule; application programs, such as software for games; software for entertainment, such as music and video data; and other programs and/or data. The center server 81 manages user information and manages the data and programs that are distributed. For example, in the case that the data is map data, version information about the map data is managed. In the case that the data is schedule data, point information including the data itself and time/date information, and the like, is managed.

In this example, the center server 81 has a portal memory device 82 that acts as a storage unit for storing distributed data and programs, a display unit 83 that is used by an operator at the information center as a monitor, a computer portion 84 that executes computer processing, an input unit 85 that is operator operated, and a communication device 86 that communicates with the communication device 65 at the user residence 61. The data and programs distributed by the center server 81 may be temporarily stored in the operation terminal 14. Following this, the communication device 65 at the user's residence 61 and the communication device 58 of the vehicular navigation device 15 are connected, and the data and programs are transmitted to the vehicular navigation device 15 from the operation terminal 14.

Note that the communication device 65 may also be a router or a home server provided with a storage unit used by a home network, or the like. In this case, the data and programs distributed by the center server 81 are temporarily stored in the storage unit of the communication device 65. When communication between the communication device 65 and the communication device 58 of the vehicular navigation device 15 is established, the data and programs are transmitted to the vehicular navigation device 15 from the communication device 65.

Alternatively, direct communication between the communication device 86 of the center server 81 and the communication device 58 of the vehicular navigation device 15 may also be executed. For example, in the case that the network 13 includes a network that is capable of communication with wireless data of a mobile phone network or a PHS phone network, and the communication device is provided with a wireless data communication modem such as a mobile phone modem or a PHS phone modem, it is possible to execute direct communication between the communication device 86 of the center server 81 and the communication device 58 of the vehicular navigation device 15.

In addition, the user can operate the operation terminal 14 so as to download data to the vehicular navigation device 15. In this case, the data includes navigation device use data, update programs, application programs, game software, entertainment use software, and data about established routes, found locations, facilities, and the like.

For example, in the case that the center server 81 provides a latest version of the map data as the navigation device use data, the user operates the operation terminal 14 so as to download the desired map data from the center server 81 to the operation terminal 14 via the communication device 65. Then, the map data is transferred to the vehicular navigation device 15 via the communication device 65, whereby it is possible to update the version of the map data stored in the vehicular navigation device 15. Moreover, temporary downloading to the operation terminal 14 may be omitted, and the map data may be directly downloaded to the vehicular navigation device 15 from the center server 81.

If the vehicular navigation device 15 is a device capable of overwriting its drive program, the user may download an updated drive program to the vehicular navigation device 15 from the center server 81. In the case that the vehicular navigation device 15 is provided with a vehicular audio device function, the user can edit music using the operation terminal 14, and then transfer it to the vehicular navigation device 15 where it is stored. If the center server 81 distributes music, the operation terminal 14 can be operated to download the desired music from the center server 81. The music can then be transferred to the vehicular navigation device 15 where it is stored. Music may also be directly downloaded from the center server 81 to the vehicular navigation device 15.

In the case that the vehicular navigation device 15 has a static image/video image replay function, or the like, it is possible to store image data for films, and the like, in the vehicular navigation device 15, in a similar manner to music. Moreover, it is possible to upload data of static images, video images, and the like, that have been filmed by the user with a digital camera or a video camera from the operation terminal 14 or the vehicular navigation device 15 to the center server 81. Then, when necessary, it is possible to execute downloading from the center server 81 to the operation terminal 14 or the vehicular navigation device 15.

If the vehicular navigation device 15 has a function that organizes and displays timetables, schedules, and the like, the user can utilize the operation terminal 14 and use PIM software, or the like, to create timetables, schedules, and the like. The data can then be transferred to the vehicular navigation device 15 and stored therein. Note that, the center server 81 may manage timetables, schedules, or the like.

In this manner, according to this exemplary embodiment, data and programs are distributed to the vehicular navigation device 15 from the center server 81. Accordingly, it is possible for the vehicular navigation device 15 to easily utilize a large volume of data and programs. It is also possible to make the configuration of the vehicular navigation device 15 simple. As a result, it is possible to make the vehicular navigation device 15 compact and reduce the manufacturing cost thereof.

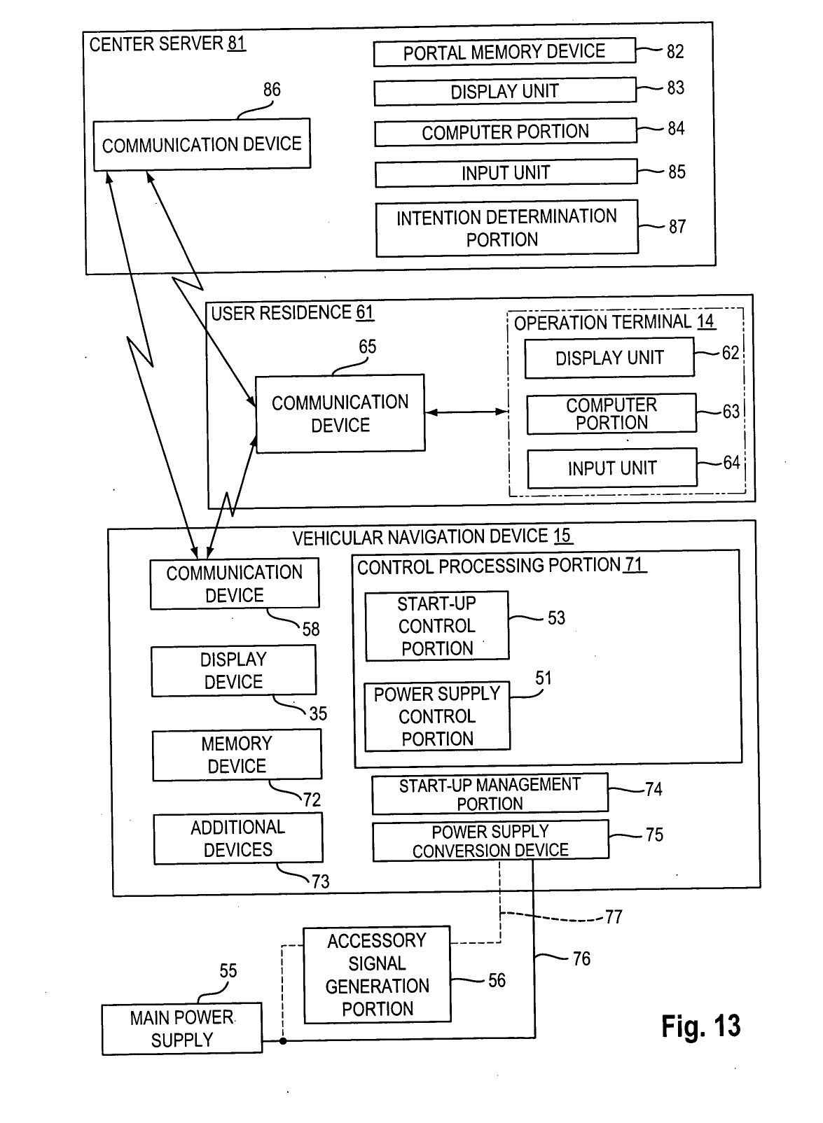

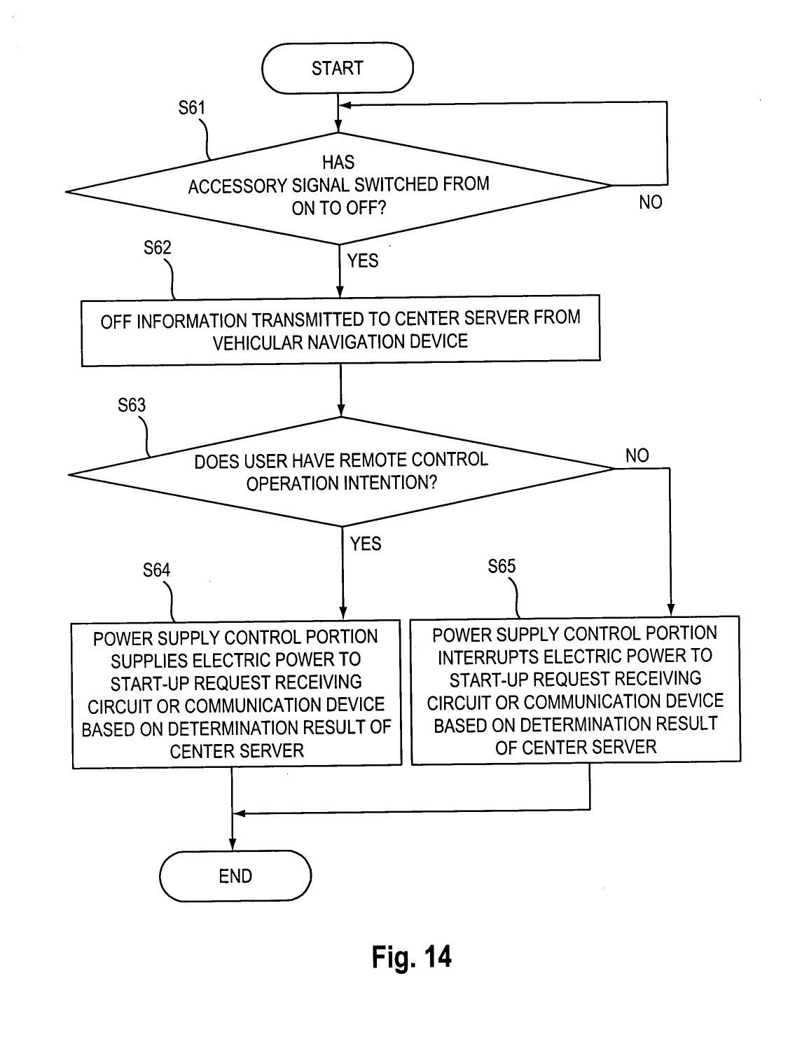

A third exemplary embodiment of the invention will be explained with reference to FIGS. 13 and 14. Note that structural members that are the same as those of the first and second exemplary embodiments are denoted with the same reference numerals, and an explanation thereof is omitted. Further, an explanation of operations and effects that are the same as those of the first and second embodiments is also omitted. FIG. 13 shows a configuration of a power supply management system for an on-board device of the third exemplary embodiment of the invention; and FIG. 14 is a flow chart showing an operation of the power supply management system for an on-board device of the third exemplary embodiment of the invention.

In this exemplary embodiment, the vehicular navigation device 15 does not have the intention determination portion 57, but rather the center server 81 is provided with an intention determination portion 87. The intention determination portion 87 of this exemplary embodiment has the same functions as the intention determination portion 57 of the second exemplary embodiment. Further, the power supply control portion 51 is configured such that, when the intention determination portion 87 determines that the remote control operation intention exists based on determination as to whether the user has the remote control operation intention, supply of electric power to the start-up request receiving circuit 52 from the main power supply 55 is permitted. Note that the configuration of other sections is the same as that of the second exemplary embodiment, and thus an explanation thereof will be omitted.

Next, the operation of the power supply management system for an on-board device of this embodiment will be explained with reference to FIG. 14. First, the control processing portion 71 of the vehicular navigation device 15 determines whether the accessory signal of the accessory signal generation portion 56 has switched from ON to OFF. If the accessory is ON, the determination is repeatedly executed. On the other hand, when it is switched OFF has been executed, the communication device 58 transmits information that indicates that the accessory signal has switched to OFF to the communication device 86 of the center server 81. Note that the OFF information may be transmitted to the communication device 86 of the center server 81 via the communication device 65 of the user residence 61.

Then, when the communication device 86 receives the OFF information, the intention determination portion 87 determines whether the user has the remote control operation intention. If the intention determination portion 87 determines that the user has the remote control operation intention, the communication device 86 of the center server 81 transmits the determination result to the communication device 58 of the vehicular navigation device 15. When the determination result is transmitted to the communication device 58 of the vehicular navigation device 15, the power supply control portion 51 supplies electric power to the start-up request receiving circuit 52 or the communication device 58. Note that the determination result may be transmitted to the communication device 58 of the vehicular navigation device 15 via the communication device 65 at the user residence 61.

On the other hand, if the intention determination portion 87 determines that the user does not have the remote control operation intention, the communication device 86 of the center server 81 transmits the determination result to the communication device 58 of the vehicular navigation device 15. Then, the determination result is transmitted to the power supply control portion 51 from the communication device 58, and the-power supply control portion 51 interrupts electric power to the start-up request receiving circuit 52 or the communication device 58. Note that the determination result may be transmitted to the communication device 58 of the vehicular navigation device 15 via the communication device 65 at the user residence 61.

In this example, the intention determination portion 87 determines whether the user has the remote control operation intention based on five determination items: a position; a time/date that is pre-set by the user; a time/date that is pre-registered in the center server 81 (for example, a time/data when new programs and data are distributed, which is set by the controller of the center server 81); a time/date of a user's timetable/schedule that is managed by the center server 81; and a user request (for example, a request for distribution of programs or data from the center server 81). Note that the five determination items can be suitably combined. For example, by combining two or more of the determination items among the five determination items, it is possible to create 26 various combinations.

When the intention determination portion 87 determines whether the user has the remote control operation intention based upon the position, the intention determination portion 87 determines whether the present position of the vehicle 11 is within the registered position area. Note that, in the case that it is determined whether the user has the remote control operation intention based upon the time/date pre-set by the user or the time/date pre-registered in the center server 81, the intention determination portion 87 determines whether the present time is the predetermined time/date based upon a clock (not shown). Further, in the case that it is determined whether the user has the remote control operation intention based upon the existence of the user request, the intention determination portion 87 determines whether the user request has been received from the vehicular navigation device 15 prior to the time point when the OFF information is received by the communication device 86.

The above-described process is summarized in the flow chart shown in FIG. 14. As shown in FIG. 14, in step S61, it is determined whether the accessory signal has switched from ON to OFF. If switching to OFF has been executed, operation continues to step S62. If switching to OFF has not been executed, operation returns to step S61. In step S62, the OFF information is transmitted to the center server 81 from the vehicular navigation device 15. Then, in step S63, it is determined whether the user has the remote control intention. If the user has the remote control operation intention, operation continues to step S64. If the user does not have the remote control operation intention, operation jumps to step S65.

In step S64, the power supply control portion 51 supplies electric power to the start-up request receiving circuit 52 or the communication device 58, based on the determination result of the center server 81. In step S65, the power supply control portion 51 interrupts the supply of electric power to the start-up request receiving circuit 52 or the communication device 58 based on the determination result of the center server 81.

In this manner, in this exemplary embodiment, when the center server 81 determines that the user has the remote control operation intention and transmits this determination result to the communication device 58 of the vehicular navigation 15, the power supply control portion 51 supplies the electric power or interrupts the supply of electric power to the start-up request receiving circuit 52 or the communication device 58. Accordingly, the configuration of the vehicular navigation device 15 can be made more compact, and it is possible to reduce the manufacturing cost thereof.

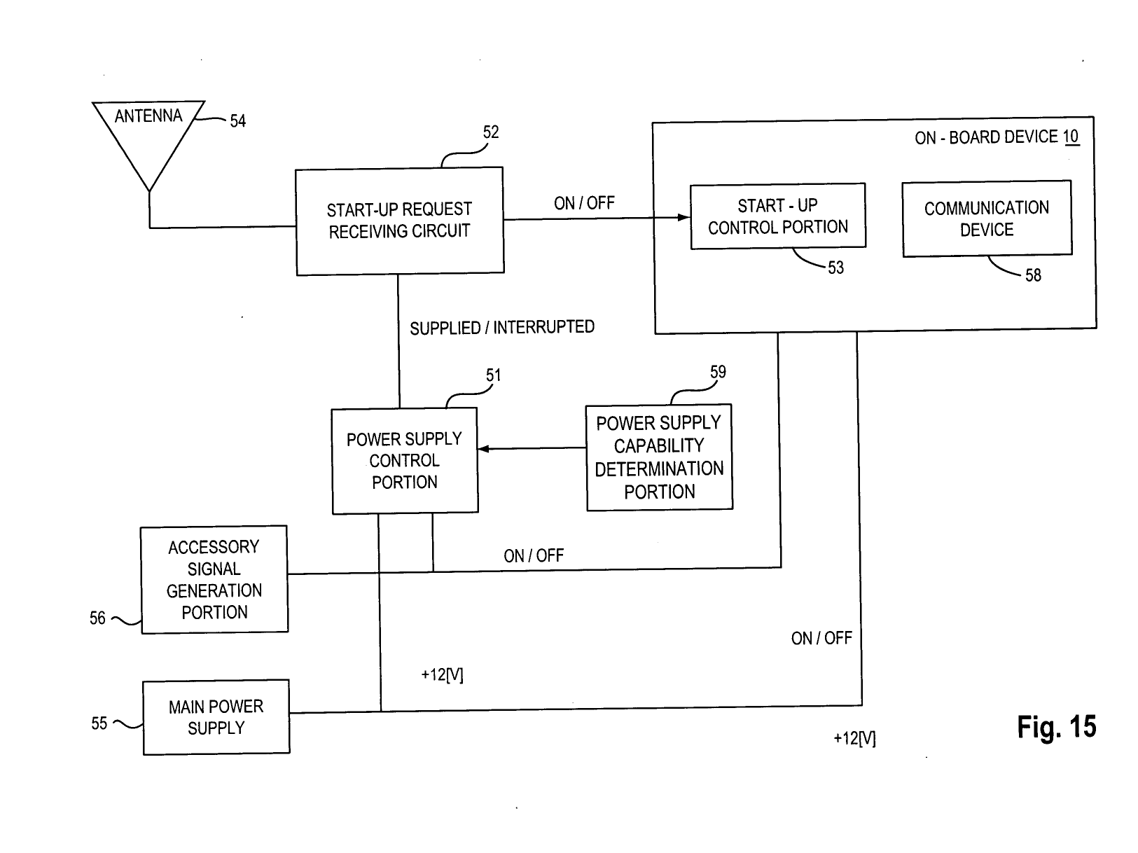

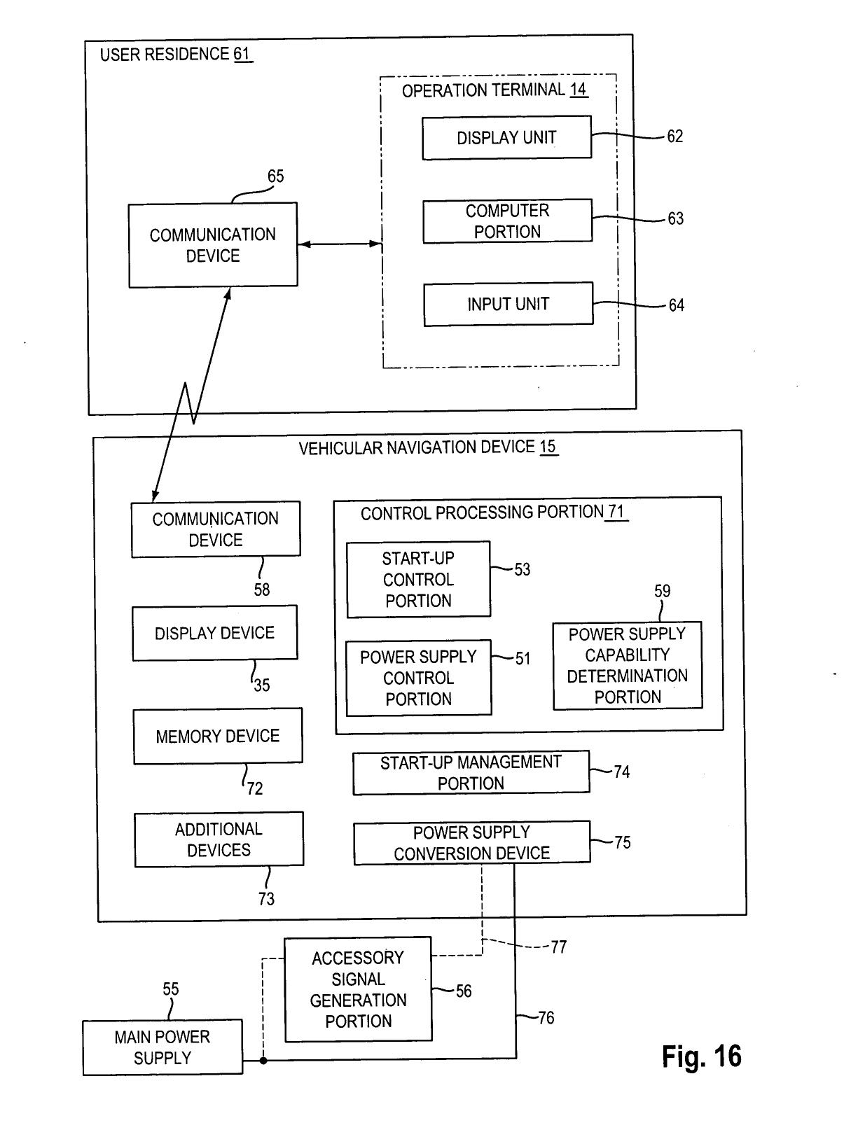

A fourth exemplary embodiment of the invention will be explained with reference to FIGS. 15 and 16. Note that structural members that are the same as those of the first to third embodiments are denoted with the same reference numerals, and an explanation thereof is omitted. Further, an explanation of operations and effects that are the same as those of the first to third embodiments is also omitted. FIG. 15 shows a configuration of a power supply management system for an on-board device of the fourth exemplary embodiment of the invention. FIG. 16 shows a configuration of the power supply management system for an on-board device of the fourth exemplary embodiment of the invention when the on-board device is a vehicular navigation device.

The power supply management system for an on-board device of this embodiment, as shown in FIG. 15 and FIG. 16, is different to the power supply management system for an on-board device of the first exemplary embodiment in that a power supply capability determination portion 59 is provided instead of the intention determination portion 57. In this example, the power supply control portion 51 is configured such that, when the power supply capability determination portion 59 determines that there is electric power supply capability based on a determination as to whether the main power supply 55 is capable of supplying electric power, supply of electric power from the main power supply 55 to the start-up request receiving circuit 52 is permitted. In other words, the power supply control portion 51 is configured such that, when the power supply capability determination portion 59 determines that there is electric power supply capability (based upon determination of whether or not there is electric power supply capability using information that indicates an environmental condition or the capability of the power supply), electric power is supplied to the start-up request receiving circuit 52. When the power supply capability determination portion 59 determines that there is no electric power supply capability, the supply of electric power to the start-up request receiving circuit 52 is interrupted.

Further, the power supply capability determination portion 59 determines whether the main power supply-55 that acts as the power supply has electric power supply capability based upon the information indicating the environmental condition or the capability of the power supply. In this example, the environmental condition is a temperature outside of the vehicle 11, namely, an outside temperature. If the outside temperature is equal to or above a predetermined value, the power supply capability determination portion 59 determines that there is electric power supply capability. When the main power supply 55 is the vehicle battery, generally, electric power supply capability thereof is strongly influenced by temperature. Thus when the temperature becomes cold it becomes impossible to supply sufficient electric power. In this case, the power supply capability determination portion 59 determines whether or not the main power supply 55 has electric power supply capability based upon the outside temperature of the vehicle 11. If the outside temperature is equal to or above a predetermined temperature, for example, −10° C., it is determined that there is electric power supply capability. If the outside temperature is less than the predetermined temperature, it is determined that there is not electric power supply capability. Note that an engine control device (not shown) of the vehicle 11, usually detects the outside temperature in order to supply an appropriate air-fuel mixture to the engine. Accordingly, it is possible for the power supply capability determination portion 59 to utilize the outside temperature detected by the engine control device.

Information that may be used to indicate the capability of the power supply includes, for example, an inter-terminal voltage of the main power supply 55, an electrolyte volume of the main power supply 55, or a usage period of the main power supply 55. In the case that there is electric power supply capability, namely, the State of Charge (SOC) is sufficiently high, an open terminal voltage taken as the inter-terminal voltage shows a reference value, but in the case that the SOC falls, a low value is shown. Here, if the inter-terminal voltage is equal to or above a predetermined value, it can be determined that electric power supply capability of the main power supply 55 is sufficiently high. Alternatively, if the inter-terminal voltage is below the predetermined value, it can be determined that electric power supply capability of the main power supply 55 in not sufficiently high. For example, in the case that the main power supply 55 is a vehicle battery with a reference value for inter-terminal voltage of 12V, generally, when the inter-terminal voltage is below 10V, it is difficult to start the engine. Accordingly, the power supply capability determination portion 59 determines whether the main power supply 55 has electric power supply capability based on the inter-terminal voltage of the main power supply 55. If the inter-terminal voltage is equal to or more than 10V, which is the necessary voltage for the engine to be started, it is determined that there is electric power supply capability. If the inter-terminal voltage is lower than the predetermined value, it is determined that there is not electric power supply capability. Note that a warning device (not shown) of the vehicle 11 normally detects the inter-terminal voltage of the main power supply 55 and issues a warning when the inter-terminal voltage is low. Accordingly, the power supply capability determination portion 59 can utilize the inter-terminal voltage detected by the warning device.

Further, in the case that the main power supply 55 uses an electrolyte, as in the case of a vehicle battery, when the electrolyte volume falls, adequate functioning is no longer possible and the power supply capability reduces. In this case, the power supply capability determination portion 59 determines whether the main power supply 55 has electric power supply capability based on the electrolyte volume of the main power supply 55. When the electrolyte volume is equal to or above a predetermined value, it is determined that the main power supply 55 has the electric power supply capability. When the electrolyte volume is below a predetermined value, it is determined that the main power supply 55 does not have the power supply capability. Note that the warning device normally detects the electrolyte volume of the main power supply 55 and issues a warning when the electrolyte volume is low. Accordingly, the power supply capability determination portion 59 can utilize the electrolyte volume detected by the warning device.

Further, since the main power supply 55 deteriorates with time, the power supply capability thereof gradually decreases. For example, when the main power supply 55 is a vehicle battery, it has deteriorated in a few years to the extent that the power supply capability significantly decreases. Therefore, the power supply capability determination portion 59 determines whether the main power supply 55 has electric power supply capability based on a usage period of the main power supply 55. When the usage period is a predetermined value, such as three years, or less, it is determined that the main power supply 55 has the electric power supply capability. When the usage period is longer than the predetermined value it is determined that the main power supply 55 does not have the power supply capability. Note that a timing at which the main power supply 55 is replaced is input to the warning device, and the warning device prompts replacement thereof when a usage period measured starting from the aforementioned timing becomes longer than the predetermined usage period. Accordingly, the power supply capability determination portion 59 can utilize the usage period measured by the warning device.

FIG. 16 shows the configuration of the power supply management system for an on-board device 10 when the on-board device is the vehicular navigation device 15. According to this exemplary embodiment, the control processing portion 71 has an integrated control processing function for the operation of the vehicular navigation device 15, and is provided with the power supply control portion 51, the start-up control portion 53, and the power supply capability determination portion 59. Note that the configuration of other sections is the same as that of the first embodiment, and thus an explanation thereof will be omitted.

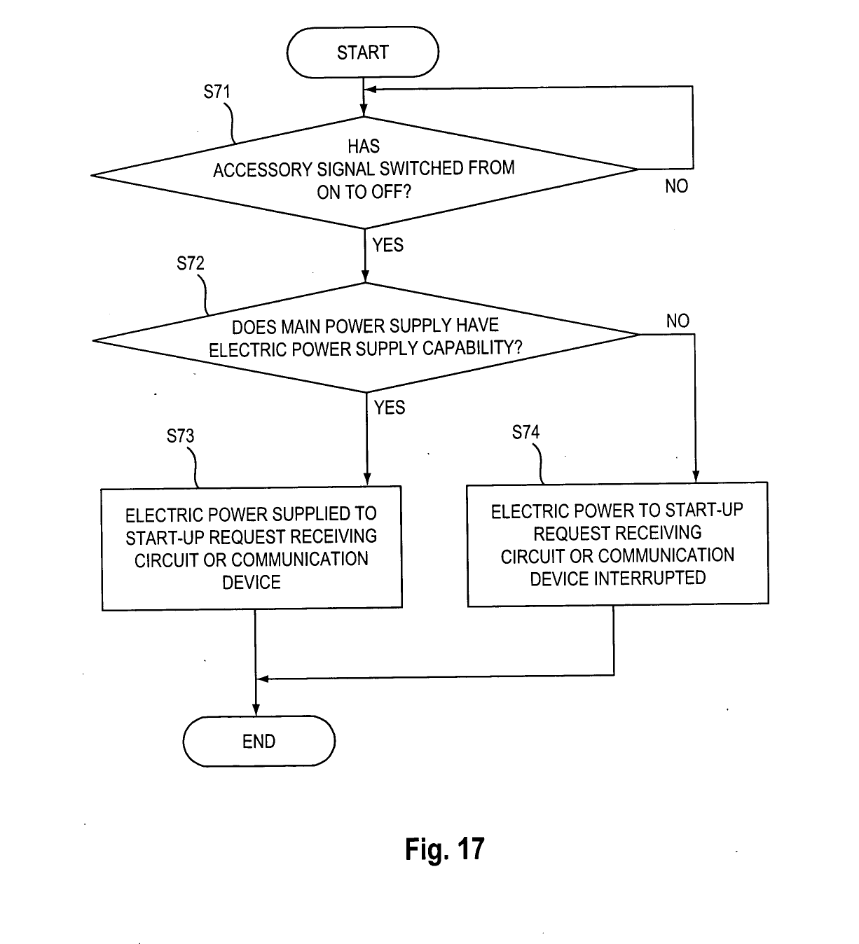

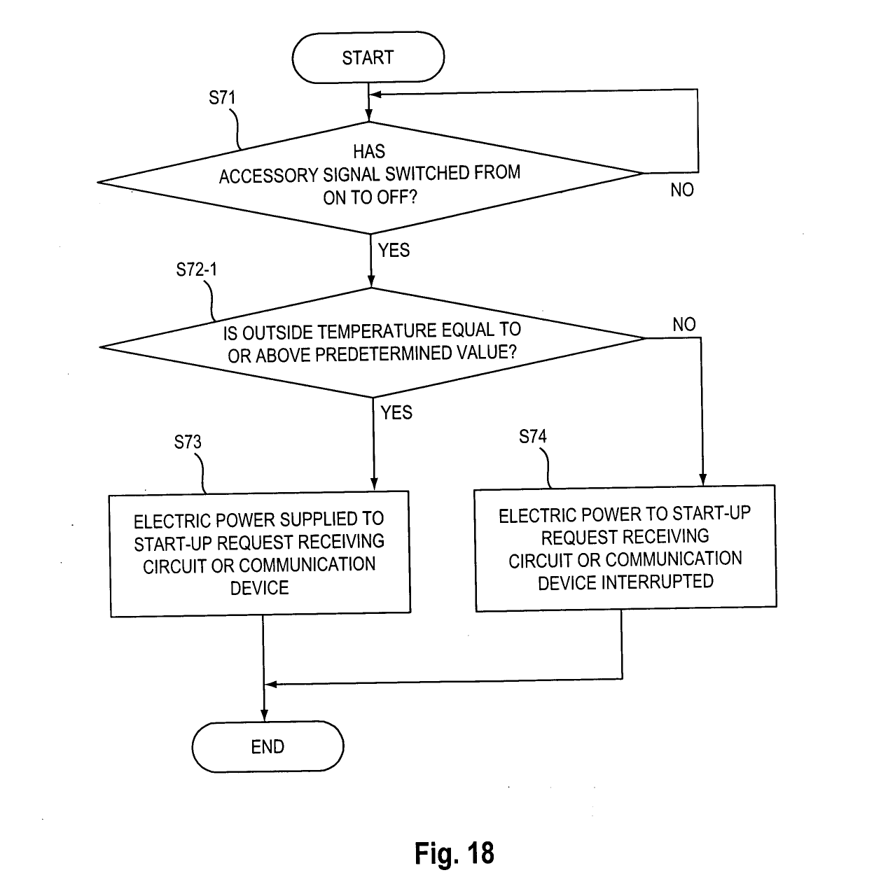

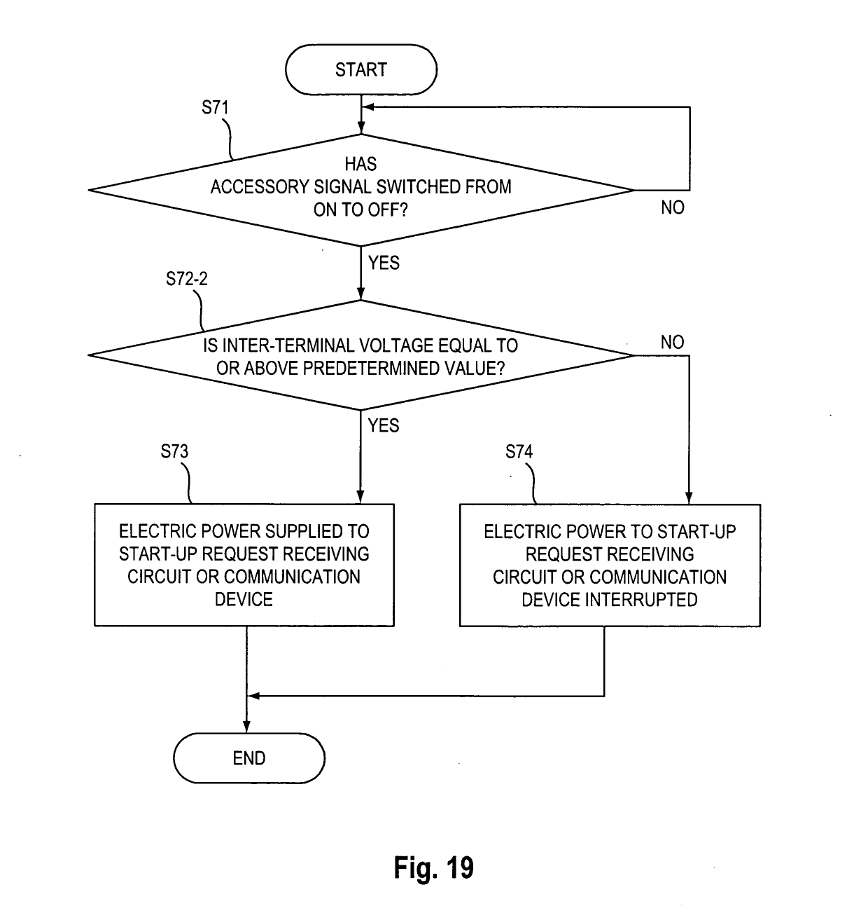

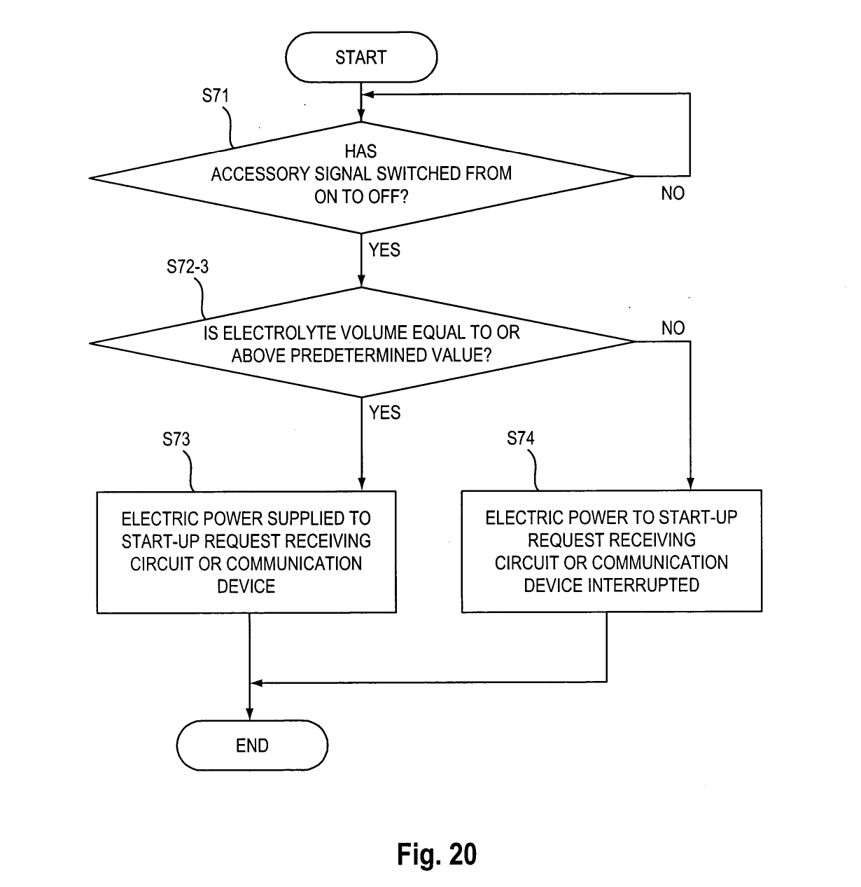

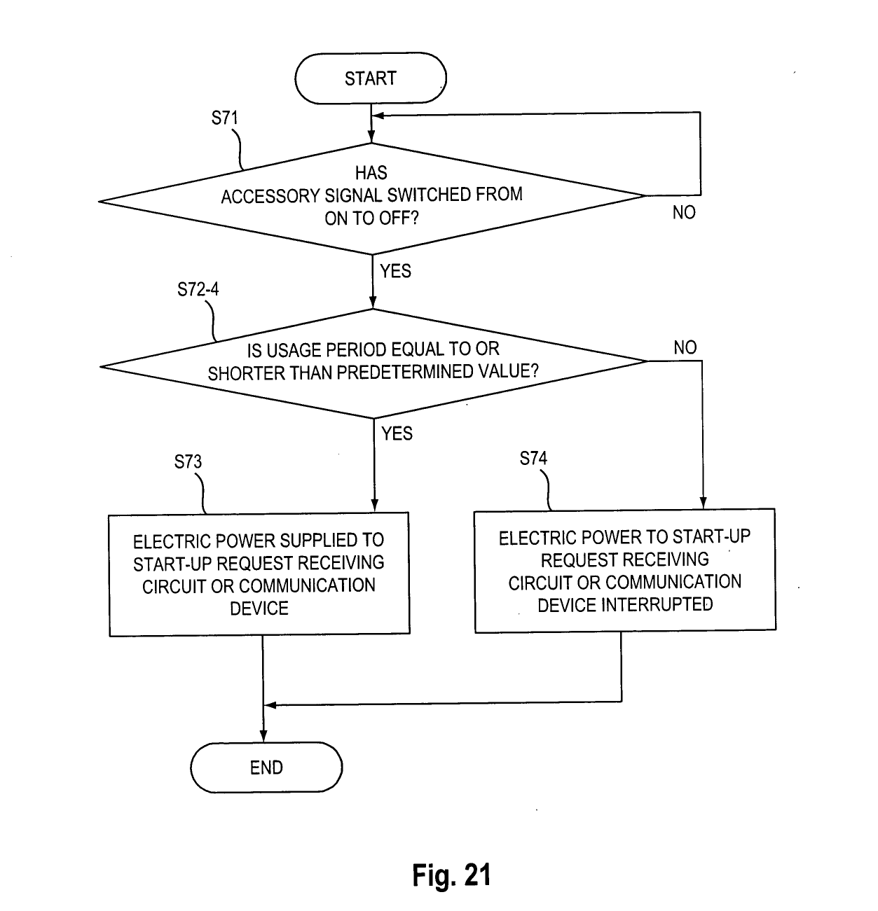

Next, the operation of the power supply management system for an on-board device with the above configuration will be explained with reference to FIGS. 17-21. FIG. 17 is a flow chart showing an operation of the power supply management system for an on-board device of the fourth exemplary embodiment of the invention; FIG. 18 is a flow chart showing an operation of the power supply management system for an on-board device of the fourth exemplary embodiment of the invention when the environmental condition is the outside temperature; FIG. 19 is a flow chart showing an operation of the power supply management system for an on-board device of the fourth exemplary embodiment of the invention when the information indicating electric power supply capability is the inter-terminal voltage of the power supply; FIG. 20 is a flow chart showing an operation of a power supply control portion of the fourth exemplary embodiment of the invention when the information indicating electric power supply capability is an electrolyte volume of the power supply; and FIG. 21 is a flow chart showing an operation of the power supply control portion of the fourth exemplary embodiment of the invention when the information indicating electric power supply capability is the usage period of the power supply.

Here, an explanation will be given for the case when the vehicle 11 is parked in the parking space at the user's home, and data is transmitted to the on-board device 10 via the operation terminal 14.

First, the control processing portion 71 determines whether the accessory signal of the accessory signal generation portion 56 has switched to OFF from ON. In the case it is ON, the determination is repeatedly executed. Further, in the case that switching to OFF has been executed, the power supply capability determination portion 59 determines whether the main power supply 55 has electric power supply capability. If the power supply capability determination portion 59 determines that the main power supply 55 has electric power supply capability, the power supply control portion 51 supplies electric power to the start-up request receiving circuit 52 or the communication device 58. If the power supply capability determination portion 59 determines that the main power supply 55 does not have electric power supply capability, the power supply control portion 51 interrupts the supply of power to the start-up request receiving circuit 52 or the communication device 58.

The above-described process is summarized in the flow chart of FIG. 17. As shown in FIG. 17, in step S71, it is determined whether the accessory signal has switched from ON to OFF. If switching to OFF has been executed, operation continues to step S72. If switching to OFF has not been executed, operation returns to step S71. Then, in step S72, it is determined whether the main power supply 55 has electric power supply capability. If there is electric power supply capability, operation continues to step S73. If there is not electric power supply capability, operation jumps to step S74. In step S73, electric power is supplied to the start-up request receiving circuit 52 or the communication device 58. In step S74, supply of electric power to the start-up request receiving circuit 52 or the communication device 58 is interrupted.

In the case that the power supply capability determination portion 59 determines whether there is electric power supply capability based upon the outside temperature as the environmental condition, the power supply capability determination portion 59 determines whether the outside temperature is equal to or above a predetermined temperature. Here, the predetermined temperature is set at, for example, −10° C. In the case that the outside temperature is equal to or above −10° C., the power supply capability determination portion 59 determines that the main power supply 55 has electric power supply capability. Thus, electric power is supplied to the start-up request receiving circuit 52 or the communication device 58. Alternatively, if the outside temperature is less than −10° C., the power supply capability determination portion 59 determines that the main power supply 55 does not have electric power supply capability, and the power supply control portion 51 interrupts the supply of electric power to the start-up request receiving circuit 52 or the communication device 58.

The above-described process is summarized in the flow chart shown in FIG. 18. As shown in FIG. 18, in step S71, it is determined whether the accessory signal has switched from ON to OFF. If switching to OFF has been executed, operation continues to step S72-1. If switching to OFF has not been executed, operation returns to step S71. Then, in step S72-1, it is determined whether the outside temperature is equal to-or above the predetermined temperature. If the outside temperature is equal to or above the predetermined temperature, operation continues to step S73. If the outside temperature is below the predetermined temperature, operation jumps to step S74. In step S73, electric power is supplied to the start-up request receiving circuit 52 or the communication device 58. In step S74, supply of electric power to the start-up request receiving circuit 52 or the communication device 58 is interrupted.

In the case that the power supply capability determination portion 59 determines whether there is electric power supply capability based on the inter-terminal voltage of the power supply as the information that indicates the capability of the power supply, the power supply capability determination portion 59 determines whether the inter-terminal voltage of the main power supply 55 is equal to or above a predetermined value. Here, the predetermined value is set to be, for example, 10V. Accordingly, in the case that the inter-terminal voltage of the main power supply 55 is equal to or more than 10V, the power supply capability determination portion 59 determines that the main power supply 55 has electric power supply capability. Thus, the power supply control portion 51 supplies electric power to the start-up request receiving circuit 52 or the communication device 58. In the case that the inter-terminal voltage of the main power supply 55 is lower than the 10V, the power supply capability determination portion 59 determines that the main power supply 55 does not have electric power supply capability. Thus, the power supply control portion 51 interrupts the supply of electric power to the start-up request receiving circuit 52 or the communication device 58.

The above-described process is summarized in the flow chart shown in FIG. 19. As shown in FIG. 19, in step S71, it is determined whether the accessory signal has switched from ON to OFF. If switching to OFF has been executed, operation continues to step S72-1. If switching to OFF has not been executed, operation returns to step S71. In step S72-2, it is determined whether the inter-terminal voltage is equal to or above the predetermined value. If the inter-terminal voltage is equal to or above the predetermined value, operation continues to step S73. If the inter-terminal voltage is below the predetermined value, operation jumps to step S74. In step S73, electric power is supplied to the start-up request receiving circuit 52 or the communication device 58. In step S74, supply of electric power to the start-up request receiving circuit 52 or the communication device 58 is interrupted.

In the case that the power supply capability determination portion 59 determines whether the main power supply 55 has electric power supply capability based on the electrolyte volume of the power supply as the information indicating the capability of the power supply, the power supply capability determination portion 59 determines whether the electrolyte volume of the main power supply 55 is equal to or above a predetermined value. In the case that the electrolyte volume is equal to or above the predetermined value it is determined that there is electric power supply capability. Accordingly, the power supply control portion 51 supplies electric power to the start-up request receiving circuit 52 and the communication device 58. Alternatively, when the electrolyte volume is below the predetermined value, it is determined that there is not electric power supply capability. Thus, the power supply control portion 51 interrupts the supply of electric power to the start-up request receiving circuit 52 or the communication device 58.

The above-described process is summarized in the flow chart of FIG. 20. As shown in FIG. 20, in step S7 1, it is determined whether the accessory signal has switched from ON to OFF. If switching to OFF has been executed, operation continues to step S72-3. If switching to OFF has not been executed, operation returns to step S71. Then, in step S72-3, it is determined whether the electrolyte volume is equal to or above the predetermined value. If the electrolyte volume is equal to or above the predetermined value, operation continues to step S73. If the electrolyte volume is below the predetermined value, operation jumps to step S74. In step S73, electric power is supplied to the start-up request receiving circuit 52 or the communication device 58. In step S74, supply of electric power to the start-up request receiving circuit 52 or the communication device 58 is interrupted.

In the case that the power supply capability determination portion 59 determines whether there is electric power supply capability based upon the usage period of the power supply as the information indicating the capability of the power supply, the power supply capability determination portion 59 determines whether the usage period is equal to or shorter than a predetermined value. Here, the predetermined value is, for example, three years or less. Accordingly, in the case that the usage period of the main power supply 55 is three years or less, the power supply capability determination portion 59 determines that the main power supply 55 has electric power supply capability. Thus, the power supply control portion 51 supplies electric power to the start-up request receiving circuit 52 or the communication device 58. Alternatively, in the case that the usage period of the main power supply 55 is longer than three years, the power supply capability determination portion 59 determines that the main power supply 55 does not have electric power supply capability. Thus, the power supply control portion 51 interrupts the supply of electric power to the start-up request receiving circuit 52 or the communication device 58.

The above-described process is summarized in the flow chart of FIG. 21. As shown in FIG. 21, in step S71, it is determined whether the accessory signal has switched from ON to OFF. If switching to OFF has been executed, operation continues to step S72-4. If switching to OFF has not been executed, operation returns to step S71. In step S72-4, it is determined whether the usage period is equal to or shorter than the predetermined value. If the usage period is equal to or less than the predetermined value, operation continues to step S73. If the usage period is longer than the predetermined value, operation jumps to step S74.

In step S73, electric power is supplied to the start-up request receiving circuit 52 or the communication device 58. In step S74, supply of electric power to the start-up request receiving circuit 52 or the communication device 58 is interrupted.

Here, the power supply capability determination portion 59 determines whether there is electric power supply capability based on one or more of the four determination items, namely: the outside temperature as the environmental condition, the inter-terminal voltage of the power supply, the electrolyte volume of the power supply, and the usage period of the power supply. However, it is possible to suitably combine the four determination items. For example, by combining two or more of the determination items among the four determination items, it is possible to create 11 types of combination.

It should be appreciated that other sections of the operation of the fifth exemplary embodiment are the same as those of the first exemplary embodiment and thus a description has been omitted.

In this manner, according to this exemplary embodiment, when the power supply capability determination portion 59 determines that the main power supply 55 as the power supply has electric power supply capability, electric power is supplied to the start-up request receiving circuit 52 or the communication device 58. In this example, the power supply capability determination portion 59 determines whether or not there is electric power supply capability based on the environmental condition or the information indicating the capability of the power supply.

Further, if the environmental condition is the outside temperature, the power supply capability determination portion 59 is configured such that when the outside temperature is equal to or above the predetermined value, it is determined that the main power supply 55 has electric power supply capability, and when the outside temperature is below the predetermined value, it is determined that the main power supply 55 does not have electric power supply capability.

If the information indicating the capability of the power supply is the inter-terminal voltage of the main power supply 55, the power supply capability determination portion 59 is configured such that when the inter-terminal-voltage is equal to or above the predetermined value, it is determined that the main power supply 55 has electric power supply capability, and when the inter-terminal voltage is below the predetermined value, it is determined that the main power supply 55 does not have electric power supply capability.

If the information indicating the capability of the power supply is the electrolyte volume of the main power supply 55, the power supply capability determination portion 59 is configured such that when the electrolyte volume is equal to or above the predetermined value, it is determined that the main power supply 55 has electric power supply capability, and when the electrolyte volume is below the predetermined value, it is determined that the main power supply 55 does not have electric power supply capability.

If the information indicating the capability of the power supply is the usage period of the main power supply-55, the power supply capability determination portion 59 is configured such that when the usage period is equal to or shorter than the predetermined value, it is determined that the main power supply 55 has electric power supply capability, and when the usage period is longer than the predetermined value, it is determined that the main power supply 55 does not have electric power supply capability.

Accordingly, when the outside temperature is equal to or above the predetermined value, or when the inter-terminal voltage is equal to or above the predetermined value, or when the electrolyte volume is equal to or above the predetermined value, or when the usage period is equal to or shorter than the predetermined period, the start-up request receiving circuit 52 is driven by supply of electric power thereto, and when the start-up request is received that is transmitted from the external device 12, it is possible to cause the start-up control portion 53 to start up, at the least, a portion of the on-board device 10.

Here, the portion of the on-board device 10 that is started up by the start-up control portion 53 is, for example (in the case that the data is downloaded to the on-board device 10 and stored on a magnetic disk acting as a hard disk that is provided as a storage unit of the on-board device 10) the hard disk, the RAM 32 acting as a semi-conductor body provided as the storage unit of the on-board device 10, and the CPU 31 provided as the calculating unit thereof For example, when the downloaded data is stored in the RAM 32, it is the RAM 32 and the CPU 31, or the RAM 32 alone.

In addition, when the outside temperature is less than the predetermined temperature, or when the inter-terminal voltage is less than the predetermined value, or when the electrolyte volume is less than the predetermined value, or when the usage period is longer than the predetermined period, the supply of electric power to the start-up request receiving circuit 52 or the communication device 58 is interrupted.

Accordingly, when the outside temperature is less than the predetermined temperature, or when the inter-terminal voltage is less than the predetermined value, or when the electrolyte volume is less than the predetermined value, or when the usage period is longer than the predetermined period, the supply of electric power to the start-up request receiving circuit 52 or the communication device 58 is interupted. As a result, it is possible to inhibit the discharge of the vehicle battery that acts as the main power supply 55. Further, when the outside temperature is equal to or above the predetermined value, or when the inter-terminal voltage is equal to or above the predetermined value, or when the electrolyte volume is equal to or above the predetermined value, or when the usage period is equal to or shorter than the predetermined period, the user can operate the operation terminal 14 so as to operate the on-board device 10 by remote control operation thereof, transmit data to the on-board device 10, and the like.

Accordingly, when the vehicle 11 is parked with the engine stopped, the supply of electric power to the on-board device 10 is interrupted except for when the power supply capability determination portion 59 determines that the main power supply 55 has electric power supply capability. Accordingly, it is possible to reduce discharge of the vehicle battery acting as the main power supply 55.

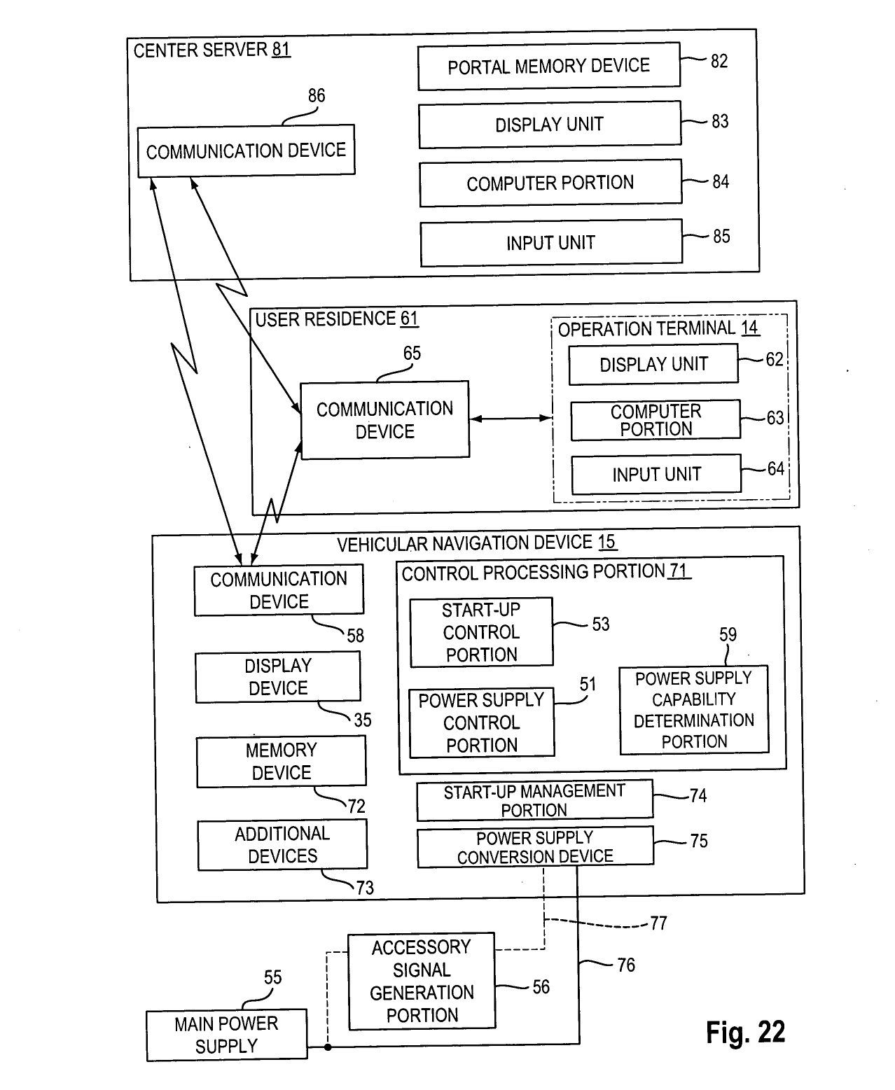

Next, a fifth exemplary embodiment of the invention will be explained with reference to FIG. 22. Note that structural members that are the same as those of the first to fourth exemplary embodiments are denoted with the same reference numerals, and an explanation thereof is omitted. Further, an explanation of operations and effects that are the same as those of the first to fourth embodiments is also omitted.

FIG. 22 shows a configuration of a power supply management system for an on-board device of the fifth exemplary embodiment of the invention. The power supply management system for an on-board device of this exemplary embodiment, like the configuration of the second exemplary embodiment, has the center server 81, and is configured such that the data and programs are distributed to the vehicular navigation device 15 from the center server 81. However, a key point of difference from the second embodiment is that the control processing portion 71 is provided with the power supply capability determination portion 59 instead of the intention determination portion 57. Note that, with regard to other sections, the configuration is the same as that of the second embodiment, and thus an explanation thereof is omitted.

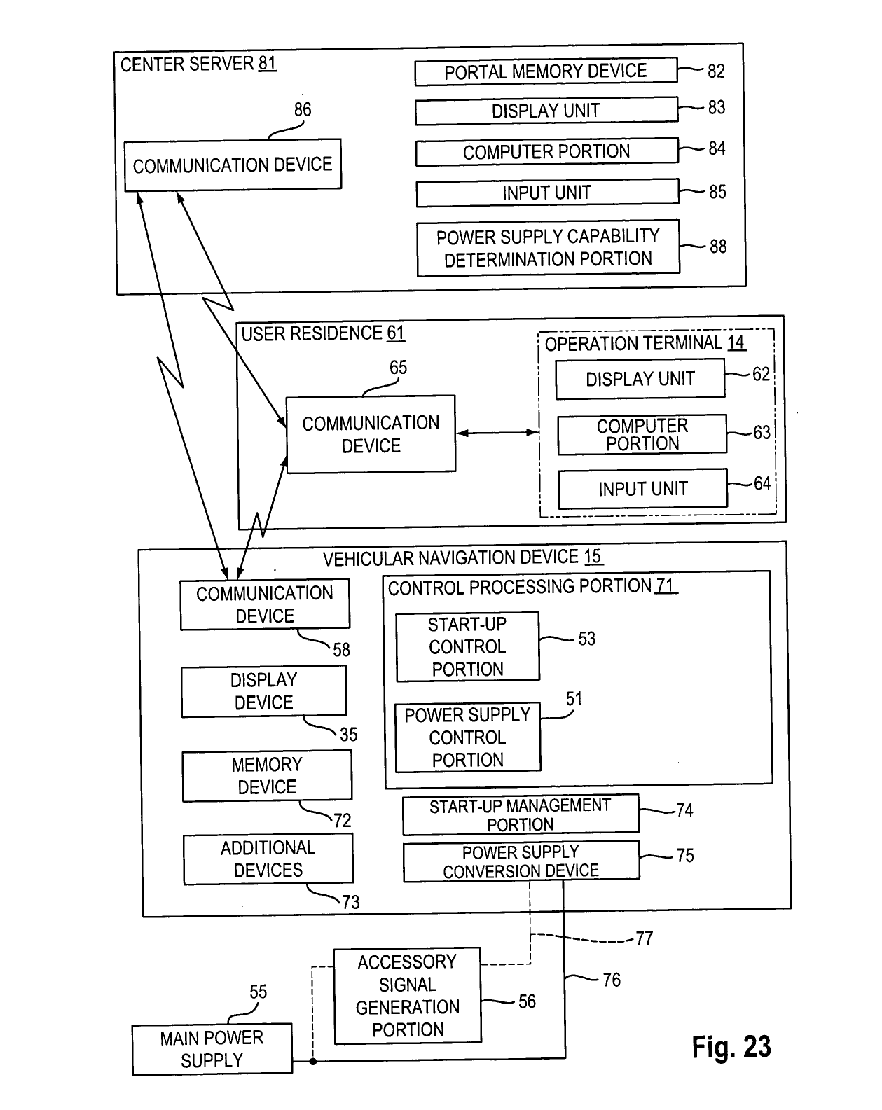

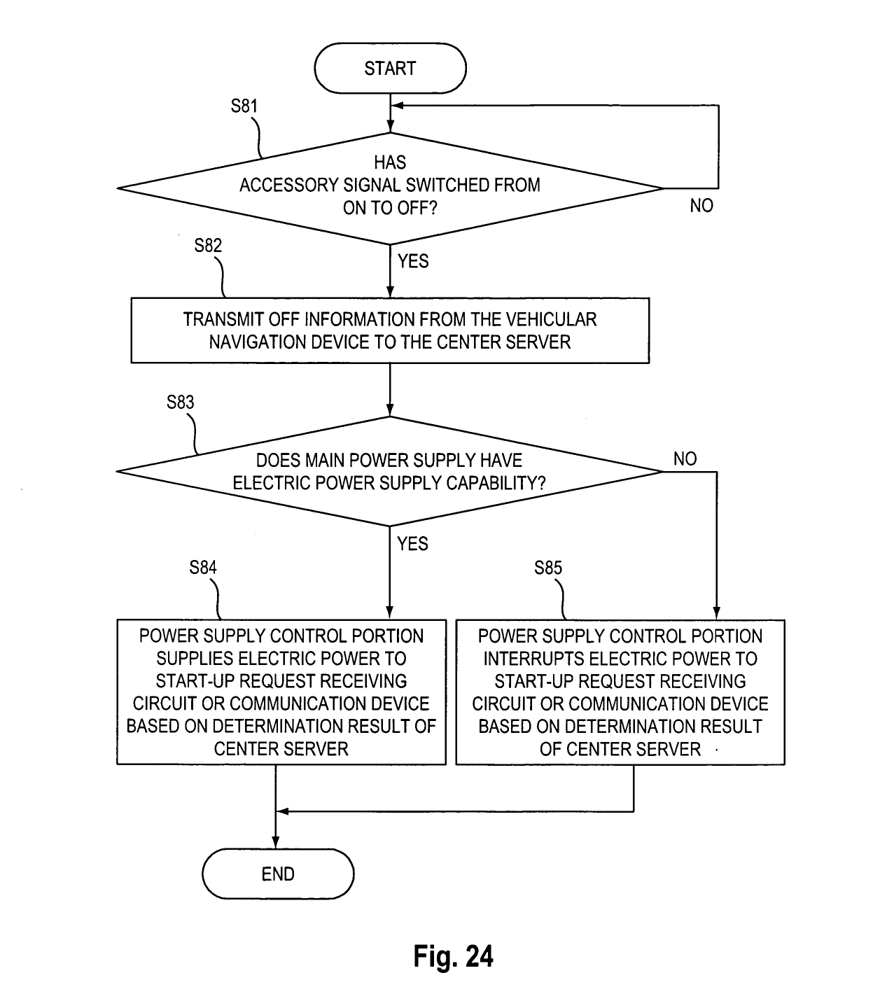

Next, a sixth exemplary embodiment of the invention will be explained with reference to FIGS. 23 and 24. Note that structural members that are the same as those of the first to fifth embodiments are denoted with the same reference numerals, and an explanation thereof is omitted. Further, an explanation of operations and effects that are the same as those of the first to fifth embodiments is also omitted. FIG. 23 shows a configuration of a power supply management system for an on-board device of the sixth embodiment of the invention; and FIG. 24 is flow chart showing an operation of the power supply management system for an on-board device of the sixth embodiment.

According to this exemplary embodiment, the vehicular navigation device 15 is not provided with the power supply capability determination portion 59, and the center server 81 has a power supply capability determination portion 88. The power supply capability determination portion 88 has the same function as the power supply capability determination portion 59. Further, the power supply control portion 51 is configured such that, when the power supply capability, determination portion 88 determines that there is electric power supply capability based on a determination as to whether the main power supply 55 has electric power supply capability, supply of electric power from the main power supply 55 to the start-up request receiving circuit 52 is permitted. Note that, other sections of the configuration are the same as those of the fifth exemplary embodiment, and thus an explanation thereof will be omitted.

Next, the operation of the power supply management system for an on-board device of this exemplary embodiment will be described. First, the control processing portion 71 of the vehicular navigation device 15 determines whether the accessory signal from the accessory signal generation portion 56 has switched from ON to OFF. Then, in the case of ON, the determination is repeatedly executed. If the control processing portion 71 determines that switching to OFF has been executed, the communication device 58 transmits information, which indicates that the accessory signal has switched from ON to OFF, to the communication device 86 of the center server 81. Note that the OFF information may be transmitted to the communication device 86 of the center server 81 via the communication device 65 of the user residence 61.

Next, when the OFF information is received by the communication device 86, the power supply capability determination portion 88 determines whether the main power supply 55 has electric power supply capability. Then, if the power supply capability determination portion 88 determines that the main power supply 55 has electric power supply capability, the communication device 86 of the center server 81 transmits the determination result to the communication device 58 of the vehicular navigation device 15. Following this, when the determination result from the communication device 58 is transmitted to the power supply control portion 51, the power supply control portion 51 supplies electric power to the start-up request receiving circuit 52 or the communication device 58. Note that the determination result may be transmitted to the communication device 58 of the vehicular navigation device 15 via the communication device 65 at the user residence 61.

When the power supply capability determination portion 88 determines that the main power supply 55 does not have electric power supply capability, the communication device 86 of the center server 81 transmits the determination result to the communication device 58 of the vehicular navigation device 15. Then, when the determination result is transmitted to the power supply control portion 51 from the communication device 58, the power supply control portion 51 interrupts the supply of electric power to the start-up request receiving circuit 52 or the communication device 58. Note that the determination result may be transmitted to the communication device 58 of the vehicular navigation device 15 via the communication device 65 of the user residence 61.

In this example, the power supply capability determination portion 88, like the power supply capability determination portion 59, determines whether there is electric power supply capability based on the four determination items, i.e., the outside temperature as the environmental condition, the inter-terminal voltage of the power supply, the electrolyte volume of the power supply, and the usage period of the power supply. However, it is possible to suitably combine the four determination items. For example, by combining two or more of the determination items among the four determination items, it is possible to create 11 types of combination.

Further, if determination of whether there is electric power supply capability is based upon the outside temperature as the environmental condition, the power supply capability determination portion 88 determines whether the outside temperature is equal to or above the predetermined value. Further, if determination of whether there is electric power supply capability is based upon the inter-terminal voltage of the power supply as the information indicating the capability of the power supply, the power supply capability determination portion 88 determines whether the inter-terminal voltage of the main power supply 55 is equal to or above the predetermined value. If determination of whether there is electric power supply capability is based upon the electrolyte volume of the power supply as the information indicating the capability of the power supply, the power supply capability determination portion 88 determines if the electrolyte volume is equal to or above the predetermined value. If determination of whether there is electric power supply capability is based upon the usage period of the power supply as the information indicating the capability of the power supply, the power supply capability determination portion 88 determines whether the usage period of the main power supply 55 is equal to or shorter than the predetermined value.

The above-described process is summarized in the flow chart shown in FIG. 24. As shown in FIG. 24, in step S81, it is determined whether the accessory signal has switched from ON to OFF. If switching to OFF has been executed, operation continues to step S82. If switching to OFF has not been executed, operation returns to step S81. In step S82, the OFF information is transmitted from the vehicular navigation device 15 to the center server 81. In step S83, it is determined whether the main power supply 55 has electric power supply capability. If there is electric power supply capability, operation continues to step S84. If there is not electric power supply capability, operation jumps to step S85.

In step S84, the power supply control portion 51 supplies electric power to the start-up request receiving circuit 52 or communication device 58 based on the determination result of the center server 81. In step S85, the power supply control portion 51 interrupts the supply of electric power to the start-up request receiving circuit 52 or the communication device 58 based on the determination result of the center server 81.

As a result, according to this exemplary embodiment, when the determination result is transmitted to the communication device 58 of the vehicular navigation device 15 following determination by the center server 81 as to whether the main power supply 55 has electric power supply capability, the power supply control portion 51 supplies or interrupts electric power to the start-up request receiving circuit 52 or the communication device 58. Accordingly, it is possible for the configuration of the vehicular navigation device 15 to be simplified. As a result, the vehicular navigation device 15 can be made more compact, whereby it is possible to reduce manufacturing costs.

While this invention has been described in conjunction with the exemplary embodiments outlined above, various alternatives, modifications, variations, and/or improvements may be possible. Accordingly, the exemplary embodiments of the invention, as set forth above, are intended to be illustrative. Various changes may be made without departing from the spirit and scope of the invention.

As described in detail above, according to the invention, when required by the user of the on-board device, and when the power supply has electric power supply capability, it is possible for electric power to be supplied to the communication device so as to place it in a communication-capable state that allows remote control operation of the on-board device. At the same time, when required by the user of the on-board device, and when the power supply does not have electric power supply capability, it is possible to interrupt the supply of electric power to the communication device, whereby it is possible to reduce discharge of the vehicle battery that acts as the power supply.

1-19. (Canceled)

20. A power supply management system for an on-board device, comprising at least one controller that:
controls start-up of an on-board device;
causes, upon receipt of a start-up request from outside of the on-board device, start-up of at least a portion of the on-board device;
determines whether a user has a remote control operation intention; and
permits, upon determination that the user has the remote control operation intention, supply of electric power to start-up the at least a portion of the on-board device.

21. A power supply management system for an on-board device, comprising at least one controller that:
controls start-up of an on-board device;
determines whether a user has a remote control operation intention; and
permits, upon determination that the user has the remote control operation intention, supply of electric power to receive a data signal; and
causes, upon receipt of the data signal from outside of the on-board device, start-up of at least a portion of the on-board device.

22. The power supply management system for an on-board device of claim 21, further comprising a wireless LAN device, wherein:
the on-board device is a vehicular navigation device, and
the data signal is received by a portion of the wireless LAN device.

23. The power supply management system for the on-board device of claim 21, further comprising a central server, wherein:
the power supply management system comprises at least two controllers;
the central server includes at least one of the at least two controllers that determines whether a user has a remote control operation intention; and
the on-board device includes another at least one of the at least two controllers that:
controls the start-up of an on-board device;
permits, when the at least one controller of the central server determines that the user has the remote control operation intention, supply of electric power to receive a data signal; and
causes, upon receipt of the data signal from outside of the on-board device, the start-up of at least a portion of the on-board device.

24. The power supply management system for the on-board device of claim 20, wherein the at least one controller determines whether the remote control operation intention exists based upon a condition set by the user.

25. The power supply management system for the on-board device of claim 24, wherein the condition relates to a position.

26. The power supply management system for an the-board device of claim 25, wherein the at least one controller determines that the user has the remote control operation intention when a present position of a vehicle is within a registered position area.

27. The power supply management system for the on-board device of claim 24, wherein the condition relates to a time.

28. The power supply management system for the on-board device of claim 27, wherein the at least one controller determines that the user has the remote control operation intention when it is a predetermined time.

29. The power supply management system for the on-board device of claim 24, wherein the condition relates to a date.

30. The power supply management system for an the-board device according to claim 29, wherein the at least one controller determines that the user has the remote control operation intention when it is a predetermined date.

31. A power supply management system for an on-board device, comprising at least one controller that:
controls start-up of an on-board device;
determines whether a power supply has electric power supply capability;
permits, upon determination that the power supply has electric power supply capability, supply of electric power to receive a start-up request from outside the on-board device; and
causes, upon receipt of the start-up request from outside of the on-board device, start up of at least a portion of the on-board device;

32. The power supply management system for the on-board device of claim 31, wherein the at least one controller determines whether there is electric power supply capability based upon an environmental condition.

33. The power supply management system for the on-board device of claim 32, wherein the environmental condition is an outside temperature.

34. The power supply management system for the on-board device of claim 31, wherein the at least one controller determines whether there is electric power supply capability based upon information indicating capability of the power supply.

35. The power supply management system for the on-board device of claim 34, wherein:
the information is an inter-terminal voltage of the power supply; and
when the inter-terminal voltage is equal to or-more than a predetermined value, the at least one controller determines that there is electric power supply capability.

36. The power supply management system for the on-board device of claim 34, wherein:
the information is an electrolyte volume of the power supply; and
when the electrolyte volume is equal to or more than a predetermined value, the at least one controller determines that there is electric power supply capability.

37. The power supply management system for the on-board device of claim 34, wherein:
the information is a usage period of the power supply; and
when the usage period is equal to or shorter than a predetermined value, the at least one controller determines that there is electric power supply capability.

38. A power supply management system for an on-board device, comprising at least one controller that:
controls start-up of an on-board device;
determines whether a power supply has electric power supply capability;
permits, upon determination that the power supply has electric power supply capability, supply of electric power to receive a data signal from outside the on-board device; and
causes, upon receipt of the data signal from outside of the on-board device, start-up of at least a portion of the on-board device.

39. The power supply management system for the on-board device of claim 38, further comprising a wireless LAN device, wherein:
the on-board device is a vehicular navigation device, and
the data signal is received by a portion of the wireless LAN device.

40. The power supply management system for an on-board device according to claim 38, further comprising a central server, wherein:
the power supply management system comprises at least two controllers;
the central server includes at least one of the at least two controllers that determines whether the power supply has electric power supply capability; and
the on-board device includes another at least one of the at least two controllers that:
controls start-up of an on-board device;
permits, upon determination that the power supply has electric power supply capability, supply of electric power to the data signal receiving portion; and
causes, upon receipt of a data signal from outside of the on-board device, start-up of at least a portion of the on-board device.

41. A method for managing the power supply of an on-board device, comprising:
receiving a start-up request;
determining whether a user has an intention to remotely control the on-board device; and
starting-up, if the user has an intention to remotely control the on-board device, at least a portion of the on-board device.

42. The method of claim 41, wherein determining whether a user has an intention to remotely control the on-board device comprises determining whether a vehicle's present position is within a predefined area.

43. The method of claim 41, wherein determining whether a user has an intention to remotely control the on-board device comprises determining whether a current time is within a predetermined time.

44. The method of claim 41, wherein determining whether a user has an intention to remotely control the on-board device comprises determining whether a current date is within a predetermined date.

45. The method of claim 41, further comprising:
determining whether the power supply is capable of supplying power to the on-board device; and
starting-up, only if the power supply is capable of supplying power to the on-board device, at least a portion of the on-board device.

46. The method of claim 45, wherein determining whether the power supply is capable of supplying power to the on-board device comprises determining whether an outside temperature is within a predetermined range.

47. The method of claim 45, wherein determining whether the power supply is capable of supplying power to the on-board device comprises determining whether an inter-terminal voltage of the power supply is within a predetermined range.

48. The method of claim 45, wherein determining whether the power supply is capable of supplying power to the on-board device comprises whether an electrolyte volume of the power supply is within a predetermined range.

49. The method of claim 45, wherein determining whether the power supply is capable of supplying power to the on-board device comprises whether a usage period of the power supply is within a predetermined range.
